(19) United States
(12) Patent Application Publication
(10) Pub. No.: US 2026/0296964 A1
(43) Pub. Date: Oct. 1, 2026

(54) Method of Forming a Stucco Composition and Products Formed Therefrom

(71) Applicants: EStav Consulting L.L.C., Charlotte, NC (US); A.M.N (Natanya) Engineering and Consulting, LTD, Natanya (IL)

(72) Inventors: Eli Stav, Charlotte, NC (US); Nechemia Masuri, Natanya (IL)

(21) Appl. No.: 19/577,904

(22) Filed: Mar. 25, 2026

Related U.S. Application Data
(60) Provisional application No. 63/777,027, filed on Mar. 25, 2025.

(51) Int. Cl. C04B 11/02; C04B 24/04; C04B 24/10; C04B 24/16; C04B 41/45; C04B 103/40; C04B 111/00

(52) U.S. Cl. CPC C04B 11/02; C04B 24/045; C04B 24/10; C04B 24/16; C04B 41/4543; C04B 2103/408; C04B 2111/00155; C04B 2111/00482

(57) ABSTRACT

The present disclosure is directed to a stucco composition and products formed therefrom. Further, the present disclosure is directed to a method of making such stucco composition. Notably, the method may include applying a coating composition to a first stucco composition having a temperature of about 70° C. or more when the coating composition is initially applied to the first stucco composition. The coating composition may include a coating additive.

### RELATED APPLICATIONS

The present application is based upon and claims priority to U.S. Provisional Patent Application Ser. No. 63/777,027, having a filing date of Mar. 25, 2025, which is incorporated herein by reference in its entirety.

### BACKGROUND OF THE INVENTION

Calcined gypsum, which may be referred to herein as stucco, products are commonly employed in drywall construction of interior walls and ceilings and also have other applications. Notably, products formed by calcined gypsum include joint compounds, plaster, gypsum cement compositions, screed, self-leveling compounds, gypsum panels, as well as other products. Generally, gypsum panels are formed from a gypsum slurry including a mixture of calcined gypsum (i.e., stucco), water, and other additives. Notably, the water to stucco ratio is an influential parameter that contributes to the fluidity of the gypsum slurry, the density of the gypsum core, and the hydration rate of the stucco in the gypsum slurry. The water to stucco ratio (i.e., the amount of water utilized to convert the stucco into gypsum) is about 0.2; however, excess water is often utilized to provide effective conversion of the stucco into gypsum and/or to ensure acceptable gypsum slurry fluidity. The use of excess water may result in additional energy used in the drying of the gypsum panel, increased production costs, and/or reduced long-term sustainability.

Thus, there is a need to provide an improved, sustainably manufactured gypsum panel that utilizes a reduced amount of water in the formation of the gypsum slurry and gypsum core. Further, there is a need to provide improved, sustainably manufactured products (e.g., gypsum products) that incorporate stucco.

### SUMMARY OF THE INVENTION

Aspects and advantages of the invention will be set forth in part in the following description, or may be obvious from the description, or may be learned through practice of the invention.

In accordance with one aspect of the present disclosure, a method of forming a stucco composition is disclosed. The method comprises: calcining gypsum to form a first stucco composition comprising stucco; and applying a coating composition to the first stucco composition to form a second stucco composition, the coating composition comprising water and a coating additive, the first stucco composition having a temperature of about 70° C. or more when the coating composition is initially applied to the first stucco composition.

In some implementations, the coating additive comprises a carbohydrate.

In some implementations, the coating additive comprises a sugar.

In some implementations, the coating additive comprises dextrose.

In some implementations, the coating additive comprises a synthetic polymer.

In some implementations, the coating additive comprises a dispersant.

In some implementations, the dispersant comprises a sulfonate.

In some implementations, the dispersant comprises a carboxylate.

In some implementations, the coating composition comprises a coating additive and a dispersant.

In some implementations, the coating additive may be a water-soluble additive.

In some implementations, the coating additive may be a water-dispersible additive.

In some implementations, the coating additive is present on the second stucco composition in an amount of about 0.01 wt. % to about 5 wt. % based on the weight of the stucco of the second stucco composition.

In some implementations, the first stucco composition has a temperature of about 80° C. or more when the coating composition is initially applied to the first stucco composition.

In some implementations, the first stucco composition has a temperature of about 100° C. or more when the coating composition is initially applied to the first stucco composition.

In some implementations, the first stucco composition has a temperature of about 200° C. or less when the coating composition is initially applied to the first stucco composition.

In some implementations, the first stucco composition has a temperature of about 100° C. to about 200° C. when the coating composition is initially applied to the first stucco composition.

In some implementations, the coating formed from the coating composition covers about 0.1% or more of the surface area of the stucco of the second stucco composition.

In some implementations, the method further comprises conditioning the second stucco composition.

In some implementations, the method further comprises applying a second coating composition to the second stucco composition.

In some implementations, the coating composition is in the form of an emulsion.

In some implementations, the coating composition is in the form of a dispersion.

In some implementations, the first stucco composition is heated and/or reheated before the coating composition is applied to the first stucco composition.

In some implementations, the first stucco composition has a temperature of about 100° C. or more when the coating composition is initially applied to the first stucco composition; and the coating additive comprises a carbohydrate, a dispersant, or a combination thereof.

In some implementations, at least a portion of the coating composition vaporizes after contacting the first stucco composition.

In some implementations, 10 wt. % or more of the coating composition vaporizes after contacting the first stucco composition.

In some implementations, the coating additive is present on the second stucco composition in an amount of about 0.01 wt. % to about 5 wt. % based on the weight of the stucco of the second stucco composition.

In some implementations, the coating composition is applied to the first stucco composition via spraying.

In accordance with aspects of the present disclosure, a product including a stucco composition (e.g., a second stucco composition) is disclosed.

In accordance with one aspect of the present disclosure, a method of making a gypsum panel is disclosed. The method comprises: providing a first facing material; depositing a gypsum slurry comprising a second stucco composition and water onto the first facing material; providing a second facing material on the gypsum slurry; and allowing the stucco to convert to calcium sulfate dihydrate.

In some implementations, the water and stucco of the gypsum slurry has a weight ratio of about 0.80 or less; and the first stucco composition has a temperature of about 100° C. or more when the coating composition is initially applied to the first stucco composition.

In some implementations, the water and stucco of the gypsum slurry have a weight ratio of about 0.75 or less.

In some implementations, the first stucco composition has a temperature of about 200° C. or less when the coating composition is initially applied to the first stucco composition.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present disclosure is directed to a method of forming a stucco composition, the stucco composition itself, and products formed therefrom. Further, the present disclosure is directed to a method of forming a gypsum panel and the resulting gypsum panel. The method may include applying a coating composition to one or more components of a gypsum panel and/or gypsum slurry, such as stucco.

Notably, the method may include applying a coating composition to one or more components of a gypsum slurry that form a hydrated gypsum core. A gypsum core formed in accordance with the present disclosure may include gypsum (i.e., calcium sulfate dihydrate), a coating composition and/or one or more components thereof, and may include other optional additives.

Additionally, the present disclosure is directed to other products and compositions that may incorporate a stucco composition, such as a joint compound composition, a plaster composition, a gypsum cement composition, a screed, or a self-leveling compound. In this respect, the present disclosure is also directed to products and compositions comprising an at least partially coated stucco composition, which may be referred to herein as a second stucco composition. Further, the present disclosure is also directed to products and compositions at least partially formed from an at least partially coated stucco composition.

A gypsum panel or other product formed in accordance with the present disclosure may be formed in a more sustainable or environmentally friendly manner as compared to the formation of traditional gypsum panels or products. For instance, a gypsum panel formed in accordance with the present disclosure may utilize less water in the formation of the gypsum slurry as compared to a traditional gypsum panel. During the production of a gypsum panel, the gypsum panel generally undergoes a drying process. Notably, a reduction in the water usage in the formation of the gypsum panel may decrease the energy utilized to dry the gypsum panel. In this respect, the energy utilized in the process of forming a gypsum panel in accordance with the present disclosure may be reduced compared to the energy utilized in the process of forming a traditional gypsum panel.

A reduction in water usage may also be advantageous for a plaster composition. In this respect, a reduced amount of water may enhance the compressive strength of a plaster composition and/or may result in faster drying of the plaster composition.

A reduction in water usage may also be advantageous for a joint compound composition. In this respect, a reduced amount of water may advantageously decrease the shrinkage of a joint compound composition.

It should be understood that throughout the entirety of this specification, each numerical value (e.g., weight percentage, concentration) disclosed should be read as modified by the term “about”, unless already expressly so modified, and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value.

It should be understood that, unless stated otherwise, any standard listed herein (e.g., ASTM) is the most recent version available as of the latest revision year. Further, it should be understood that throughout the entirety of this specification, the term “and/or” refers to one or all of the listed components or a combination of any two or more of the listed components.

Notably, some aspects of the present invention may omit one or more of the features disclosed herein.

Generally, the process of forming a product that incorporates a stucco composition (e.g., a gypsum panel, a joint compound composition, a plaster composition, a gypsum-cement composition, a screed, a self-leveling compound) includes obtaining or procuring gypsum, which may be referred to herein as calcium sulfate dihydrate. The gypsum may be ground or milled into smaller gypsum particles. The gypsum may be subjected to a thermal treatment, such as calcination, to form a first stucco composition comprising stucco, which may be referred to herein as calcium sulfate hemihydrate. In this respect, the gypsum may be calcined to form stucco. Notably, the calcination process may remove water (e.g., crystal water) from the gypsum to form stucco.

The calcination process may be performed via a heating device such as a kiln (e.g., a rotary kiln), a fluidized bed, a Calcidyne, an impact mill, a rotary mill, a kettle, an IR heating station, and/or an autoclave. Notably, the calcination process may use or involve hot air and/or gas. The calcination process may be performed via direct heating and/or indirect heating. The calcination process may be performed in a pressurized system. It should be understood that a heating device that calcines gypsum into stucco may be referred to herein as a calcination device.

In some aspects, the calcination process may be performed via an IR heating station. In some aspects, gypsum and/or stucco may be subjected to an IR heating station before being placed in a mixer. In some aspects, gypsum and/or stucco may be subjected to an IR heating station, sprayed with a coating composition, and then placed in a mixer, such as a mixer that combines one or more components of a gypsum slurry.

In some aspects, the gypsum may be calcined at a temperature from about 120° C. to about 650° C., including all increments of 1° C. therebetween.

The gypsum may be subjected to a thermal treatment (e.g., calcined) at a temperature of about 120° C. or more, such as about 130° C. or more, such as about 140° C. or more, such as about 150° C. or more, such as about 160° C. or more, such as about 170° C. or more, such as about 180° C. or more, such as about 190° C. or more, such as about 200° C. or more, such as about 300° C. or more, such as about 400° C. or more, such as about 500° C. or more, such as about 600° C. or more. The gypsum may be subjected to a thermal treatment (e.g., calcined) at a temperature of about 650° C. or less, such as about 600° C. or less, such as about 500° C. or less, such as about 400° C. or less, such as about 300° C. or less, such as about 200° C. or less, such as about 190° C. or less, such as about 180° C. or less, such as about 170° C. or less, such as about 160° C. or less, such as about 150° C. or less, such as about 140° C. or less, such as about 130° C. or less. It should be understood that any of the aforementioned temperatures, including any ranges thereof, may be the temperature of the drying device.

After leaving the calcination device, one or more coating compositions may be applied to the first stucco composition to form a second stucco composition. A portion of the second stucco composition may be at least partially coated with a coating composition and/or a component thereof. Notably, one or more components of a coating composition (e.g., one or more coating additives), such as any of the coating composition components disclosed herein, may form a coating on the stucco of the first stucco composition to form a second stucco composition. The coating may cover about 0.1% or more of the surface area (e.g., BET surface area) of the stucco of the second stucco composition, such as about 0.5% or more, such as about 1% or more, such as about 5% or more, such as about 10% or more, such as about 30% or more, such as about 50% or more.

A first stucco composition may include stucco in an amount from about 50 wt. % to about 100 wt. %, including all increments of 0.01 wt. % therebetween.

In some aspects, a first stucco composition may include stucco in an amount of about 50 wt. % or more, such as about 60 wt. % or more, such as about 70 wt. % or more, such as about 80 wt. % or more, such as about 90 wt. % or more, such as about 95 wt. % or more. In some aspects, a first stucco composition may include stucco in an amount of about 100 wt. % or less, such as about 90 wt. % or less, such as about 80 wt. % or less, such as about 70 wt. % or less, such as about 60 wt. % or less.

A second stucco composition may include stucco in an amount from about 50 wt. % to about 100 wt. %, including all increments of 0.01 wt. % therebetween.

In some aspects, a second stucco composition may include stucco in an amount of about 50 wt. % or more, such as about 60 wt. % or more, such as about 70 wt. % or more, such as about 80 wt. % or more, such as about 90 wt. % or more, such as about 95 wt. % or more. In some aspects, a second stucco composition may include stucco in an amount of about 100 wt. % or less, such as about 90 wt. % or less, such as about 80 wt. % or less, such as about 70 wt. % or less, such as about 60 wt. % or less.

After leaving the calcination device, a first stucco composition may be transported or conveyed, such as via a screw conveyor, a conveyor belt, and/or a fluidized bed. Notably, the first stucco composition may have a coating composition applied thereon while the first stucco composition is being transported or conveyed. In some aspects, the first stucco composition may be agitated or vibrated while being transported or conveyed. In some aspects, the first stucco composition may be agitated or vibrated while a coating composition is applied to the first stucco composition. In general, a series of roller bars beneath the conveyor surface, pneumatic conveying, fluidized air bed, an air gun, a screw conveyer, or other devices and/or methods that increase the exposed surface area of the stucco composition may agitate or vibrate the first stucco composition during the application of the coating composition.

A coating composition may be applied to a first stucco composition in an amount of about 0.01 wt. % to about 50 wt. %, including all increments of 1 wt. % therebetween, by weight of the stucco of the first stucco composition.

In some aspects, a coating composition may be applied to a first stucco composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 10 wt. % or more, such as about 15 wt. % or more, such as about 20 wt. % or more, such as about 30 wt. % or more, such as about 40 wt. % or more by weight of the stucco of the first stucco composition. In some aspects, a coating composition may be applied to a first stucco composition in an amount of about 50 wt. % or less, such as about 40 wt. % or less, such as about 30 wt. % or less, such as about 20 wt. % or less, such as about 15 wt. % or less, such as about 10 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less by weight of the stucco of the first stucco composition.

A coating composition may be applied to a first stucco composition having a temperature of from about 40° C. to about 200° C., including all increments of 1° C. therebetween, such as about 60° C. to about 200° C., such as about 80° C. to about 150° C., such as about 80° C. to about 120° C. It should be understood that any of the aforementioned temperatures, including any ranges thereof, may be the temperature of a first stucco composition after leaving the drying device. It should be understood that any of the aforementioned temperatures, including any ranges thereof, may be the temperature of a first stucco composition when the coating composition is initially applied to the first stucco composition.

In some aspects, after leaving the calcination device, a coating composition may be applied to a first stucco composition having a temperature of about 40° C. or more, such as about 50° C. or more, such as about 60° C. or more, such as about 70° C. or more, such as about 80° C. or more, such as about 90° C. or more, such as about 100° C. or more, such as about 110° C. or more, such as about 120° C. or more, such as about 130° C. or more, such as about 140° C. or more, such as about 150° C. or more, such as about 160° C. or more, such as about 170° C. or more, such as about 180° C. or more, such as about 190° C. or more. In some aspects, after leaving the drying device, a coating composition may be applied to a first stucco composition having a temperature of about 200° C. or less, such as about 190° C. or less, such as about 180° C. or less, such as about 170° C. or less, such as about 160° C. or less, such as about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less. It should be understood that any of the aforementioned temperatures, including any ranges thereof, may be the temperature of a first stucco composition after leaving the drying device. It should be understood that any of the aforementioned temperatures, including any ranges thereof, may be the temperature of a first stucco composition when the coating composition is initially applied to the first stucco composition.

In some aspects, the first stucco composition may be heated and/or reheated before a coating composition is applied to the first stucco composition. The first stucco composition may be heated and/or reheated to a temperature of from about 40° C. to about 200° C., including all increments of 1° C. therebetween, such as about 60° C. to about 200° C., such as about 80° C. to about 150° C., such as about 80° C. to about 120° C.

A coating composition formed in accordance with the present disclosure may include water, one or more coating additives, one or more dispersants (e.g., any of the dispersants disclosed herein), or a combination thereof. The one or more coating additives and/or one or more dispersants may be in the form of a liquid and/or a solid. The one or more coating additives may include one or more water-soluble additives and/or one or more water-dispersible additives. The one or more coating additives may be soluble in water, partially soluble in water, or insoluble in water. A coating additive may be or include a dispersant. The one or more dispersants may be water-soluble. The coating composition may be in the form of a dispersion or an emulsion (e.g., a polymeric emulsion). As used herein, the term “dispersion” refers to a liquid having solid particles dispersed therein. In some aspects, the solid particles may be organic, inorganic, or a combination thereof.

In some aspects, the one or more coating additives may include one or more carbohydrates. Notably, the one or more carbohydrates may include one or more sugars, such as one or more monosaccharides. In some aspects, the one or more carbohydrates may include dextrose. In some aspects, the one or more coating additives may include a synthetic polymer. For instance, the one or more coating additives may include polyethylene glycol.

In some aspects, the one or more dispersants may include naphthalene sulfonate, a lignosulfonate, a polycarboxylate ether, or a combination thereof. Notably, a lignosulfonate may provide a similar water reduction effect as naphthalene sulfonate when applied in a coating composition to the first stucco composition. When a lignosulfonate is added into a mixer with stucco, such as during the formation of a gypsum slurry, it may not have the same water reduction effect compared to applying the lignosulfonate in a coating composition to the first stucco composition. The use of a lignosulfonate may make the process of the present disclosure more environmentally friendly in that the use of formaldehyde may be avoided or reduced.

The one or more coating additives may be present in a coating composition in an amount of from about 0.01 wt. % to about 99.99 wt. %, including all increments of 0.01 wt. % therebetween, such as about 0.01 wt. % to about 50 wt. %, such as about 5 wt. % to about 40 wt. %, such as about 10 wt. % to about 40 wt. %.

In some aspects, the one or more coating additives may be present in a coating composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 10 wt. % or more, such as about 20 wt. % or more, such as about 30 wt. % or more, such as about 40 wt. % or more, such as about 50 wt. % or more. In some aspects, the one or more coating additives may be present in a coating composition in an amount of about 100 wt. % or less, such as about 50 wt. % or less, such as about 40 wt. % or less, such as about 30 wt. % or less, such as about 20 wt. % or less, such as about 10 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less.

The one or more dispersants, such as any of the dispersants disclosed herein, may be present in a coating composition in an amount of from about 0.01 wt. % to about 99.99 wt. %, including all increments of 0.01 wt. % therebetween.

In some aspects, the one or more dispersants may be present in a coating composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 10 wt. % or more, such as about 20 wt. % or more, such as about 30 wt. % or more, such as about 40 wt. % or more, such as about 50 wt. % or more. In some aspects, the one or more dispersants may be present in a coating composition in an amount of about 100 wt. % or less, such as about 50 wt. % or less, such as about 40 wt. % or less, such as about 30 wt. % or less, such as about 20 wt. % or less, such as about 10 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less.

In some aspects, the coating composition may include colloidal silica.

A coating composition may include water. Water may be present in a coating composition in an amount of from about 0.01 wt. % to about 99.99 wt. %, including all increments of 0.01 wt. % therebetween, such as from about 50 wt. % to about 100 wt. %, such as from about 60 wt. % to about 100 wt. %.

In some aspects, water may be present in a coating composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 10 wt. % or more, such as about 20 wt. % or more, such as about 30 wt. % or more, such as about 40 wt. % or more, such as about 50 wt. % or more. In some aspects, water may be present in a coating composition in an amount of about 100 wt. % or less, such as about 50 wt. % or less, such as about 40 wt. % or less, such as about 30 wt. % or less, such as about 20 wt. % or less, such as about 10 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less.

Generally, a coating composition and/or one or more components thereof (e.g., a coating additive) may undergo shearing in a continuous or batch shear mixer, such as a Quadro® Liquids high shear mixer, pin mixer, or an Axiflow® high shear mixer, at any time of the process disclosed herein, including during, before, and/or after any of the process steps disclosed herein. After the shear mixer has mixed a coating composition and/or one or more components thereof, the resulting coating composition, which may be in the form of a dispersion or an emulsion, may be applied (e.g., sprayed) to a first stucco composition.

The coating composition and/or one or more components thereof may be sheared at a shear rate of from about 5000 rpm to about 22000 rpm, including all increments of 1 rpm therebetween.

In some aspects, a coating composition and/or one or more components thereof may be sheared at a shear rate of about 5000 rpm or more, such as about 5500 rpm or more, such as about 6000 rpm or more, such as about 6500 rpm or more, such as about 7000 rpm or more, such as about 7500 rpm or more, such as about 8000 rpm or more, such as about 8500 rpm or more, such as about 9000 rpm or more, such as about 9500 rpm or more, such as about 10000 rpm or more, such as about 11000 rpm or more, such as about 12000 rpm or more, such as about 13000 rpm or more, such as about 14000 rpm or more, such as about 15000 rpm or more, such as about 18000 rpm or more. In some aspects, a coating composition and/or one or more components thereof may be sheared at a shear rate of about 22000 rpm or less, such as about 20000 rpm or less, such as about 18000 rpm or less, such as about 15000 rpm or less, such as about 14000 rpm or less, such as about 13000 rpm or less, such as about 12000 rpm or less, such as about 11000 rpm or less, such as about 10000 rpm or less, such as about 9500 rpm or less, such as about 9000 rpm or less, such as about 8500 rpm or less, such as about 8000 rpm or less, such as about 7500 rpm or less, such as about 7000 rpm or less, such as about 6500 rpm or less, such as about 6000 rpm or less, such as about 5500 rpm or less.

A coating composition and/or one or more components thereof may be milled (e.g., ball-milled). As used herein, “milled” is synonymous with “ground”. Notably, the milling of a coating composition and/or one or more components thereof may decrease the average particle size of one or more components of a coating composition. It should be understood that any of the components of the coating composition may be milled together or may be milled separately. When milled separately, the components of the coating composition may be combined or mixed before being applied to a first stucco composition. A coating composition and/or one or more components thereof may be milled (e.g., ball-milled) before, after, and/or during any of the process steps disclosed herein.

As previously disclosed, a coating composition and/or one or more components thereof may be ball-milled. However, it should be understood that a coating composition and/or one or more components thereof may be milled by other equipment such as, for instance, an attritor, a vibration mill, an impact mill, a planetary ball mill, a jet mill, and the like.

A coating composition may be applied by spraying (e.g., misting), curtain coating, dripping, or a combination thereof. If the coating composition is applied via spraying, the intensity and/or angle of the spraying and the distance of the spraying mechanism to a first stucco composition may affect the depth of penetration of the coating composition in the first stucco composition.

Notably, the inventors of the present disclosure have discovered that applying a coating composition to a first stucco composition may reduce the amount of water used to form a gypsum panel. In this respect, the coating provided by the coating composition may delay the reaction of water with the stucco of the second stucco composition. The delayed reaction of water with stucco retards the hydration reaction and may allow for a more even and/or homogenous reaction of the water with the stucco of the second stucco composition. Further, the coating provided by the coating composition may aid in keeping the slurry mixer clean during operation, which may reduce downtime.

As previously disclosed herein, the application of a coating composition may occur while the first stucco composition has an elevated temperature. This application method may be particularly advantageous in that the water of a coating composition may be vaporized or evaporated, such as via flash evaporation, upon contact, or shortly after contact, with the stucco, while one or more components (e.g., dextrose) of the coating composition form a coating on the stucco.

In some aspects, 5 wt. % or more of the coating composition may vaporize after contacting the first stucco composition, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Notably, the use of elevated temperatures may be particularly advantageous in that the vaporization of the water may reduce or prevent the formation of lumps in the stucco and/or the hydration of the stucco. The temperature of the first stucco composition to which the coating composition is applied may be adjusted to optimize the amount of stucco coated by the coating composition while also reducing the conversion of stucco to gypsum via the reaction of the water of the coating composition with the stucco. The temperature of the first stucco composition to which the coating composition is applied may be adjusted by air-cooling, which may involve one or more blowers or fans.

Notably, as previously disclosed herein, after a coating composition is applied to a first stucco composition, one or more components (e.g., water) of the coating composition may vaporize. A coating additive may remain on the stucco composition after one or more components of the coating composition vaporize. The coating additive may be present as crystallites, particles, deposits, residues, domains, and the like on the surface of the stucco of the second stucco composition.

In some aspects, the temperature of the coating composition may be adjusted to optimize the amount of stucco coated by the coating composition while also reducing the conversion of stucco to gypsum via the reaction of the water of the coating composition with the stucco. For instance, when applied to the first stucco composition, the coating composition may have a temperature from about 15° C. to about 110° C., including all increments of 1° C. therebetween.

In some aspects, when applied to the first stucco composition, the coating composition may have a temperature of about 15° C. or more, such as about 30° C. or more, such as about 50° C. or more, such as about 80° C. or more, such as about 100° C. or more. In some aspects, when applied to the first stucco composition, the coating composition may have a temperature of about 110° C. or less, such as about 100° C. or less, such as about 80° C. or less, such as about 50° C. or less, such as about 30° C. or less.

The one or more coating additives may be present on the second stucco composition in an amount of about 0.01 wt. % to about 5 wt. %, including all increments of 0.01 wt. % therebetween, by weight of the stucco of the second stucco composition.

In some aspects, the one or more coating additives may be present on the second stucco composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more by weight of the stucco of the second stucco composition. In some aspects, the one or more coating additives may be present on the second stucco composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less by weight of the stucco of the second stucco composition.

The dispersant may be present on the second stucco composition in an amount of about 0.01 wt. % to about 5 wt. %, including all increments of 0.01 wt. % therebetween, by weight of the stucco of the second stucco composition.

In some aspects, the dispersant may be present on the second stucco composition in an amount of about 0.01 wt. % or more, such as about 0.05 wt. % or more, such as about 0.1 wt. % or more, such as about 0.5 wt. % or more, such as about 1 wt. % or more, such as about 2 wt. % or more by weight of the stucco of the second stucco composition. In some aspects, the dispersant may be present on the second stucco composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less by weight of the stucco of the second stucco composition.

A stucco composition (e.g., a first stucco composition) may have two or more coating compositions applied thereto sequentially or simultaneously. Notably, a first coating composition may be applied to a first stucco composition followed by a second coating composition being applied to the second stucco composition. Any coating composition (e.g., a first coating composition, a second coating composition) may have any of the properties, characteristics, and/or components of a coating composition as disclosed herein. Notably, one or more coating compositions (e.g., a first coating composition) may be different from one or more other coating compositions (e.g., a second coating composition). For instance, a first coating composition may include a carbohydrate and a second coating composition may include a dispersant. Generally, a stucco composition may be coated with two or more coating compositions before, during, and/or after any of the process steps disclosed herein.

After the application of a coating composition to a first stucco composition to form a second stucco composition, the second stucco composition may be conditioned. Notably, the conditioning of a second stucco composition may cool the second stucco composition. The second stucco composition may be conditioned by a conditioning device such as a mixer (e.g., rotary mixer) or a fluidized bed, in a continuous or batch process. In some aspects, the second stucco composition may be air-cooled, which may involve one or more blowers or fans.

In some aspects, a second stucco composition may be conditioned by utilizing a mixer to aerate and/or cool the second stucco composition. Such mixers generally range in size and height, but an example of such a mixer used can have a diameter that falls within the range of from about 12 inches to about 24 inches. Notably, the mixer may be equipped with a mechanism to introduce cold air into the mixer. For instance, the mixer may include one or more vortex tubes and/or one or more air nozzles.

In some aspects, a second stucco composition may be conditioned by utilizing a fluidized bed, a stucco cooler, or more generally any device configured to condition a stucco composition. One or more of the aforementioned devices may be utilized to aerate and/or cool the second stucco composition.

In some aspects, the second stucco composition may be heated and/or reheated before being included or added to a gypsum slurry or a mixer including components of the gypsum slurry.

In some aspects, a second stucco composition may be added to the gypsum slurry and/or a mixer including components of the gypsum slurry while the second stucco composition has a temperature of about 10° C. or more, such as about 15° C. or more, such as about 20° C. or more, such as about 30° C. or more, such as about 40° C. or more, such as about 50° C. or more, such as about 60° C. or more, such as about 70° C. or more, such as about 80° C. or more, such as about 90° C. or more. In some aspects, a second stucco composition may be added to the gypsum slurry and/or a mixer including components of the gypsum slurry while the second stucco composition has a temperature of about 110° C. or less, such as about 100° C. or less, such as about 90° C. or less, such as about 80° C. or less, such as about 70° C. or less, such as about 60° C. or less, such as about 50° C. or less, such as about 40° C. or less, such as about 30° C. or less, such as about 20° C. or less.

The second stucco composition and/or one or more components thereof may be combined with other components and may undergo other processing steps to form any of the products disclosed herein, such as a gypsum panel, a joint compound composition, and/or a plaster composition.

### Gypsum Panel

Notably, the second stucco composition and/or one or more components thereof may be combined with other components to form a gypsum slurry. The coated stucco of the second stucco composition may replace at least a portion of uncoated stucco generally used to form a gypsum slurry. The manner in which the components of the gypsum slurry are combined is not necessarily limited. For instance, the gypsum slurry can be made using any method or device generally known in the art. In particular, the components of the gypsum slurry can be mixed or combined using any method or device generally known in the art. The components of the gypsum slurry may be combined in any type of device, such as a mixer (e.g., pin mixer, pinless mixer). In this regard, the manner in which the components are incorporated into the gypsum slurry is not necessarily limited by the present disclosure. Such components may be provided prior to a mixing device, directly into a mixing device, in a separate mixing device, and/or even after the mixing device. For instance, the respective components may be provided prior to a mixing device. In another embodiment, the respective components may be provided directly into a mixing device. For instance, in one embodiment, the foaming agent or soaps may be provided directly into the mixer. Alternatively, the respective components may be provided after the mixing device (such as to the canister or boot, using a secondary mixer, or applied directly onto the slurry after a mixing device) and may be added directly or as part of a mixture. Whether provided prior to, into, or after the mixing device, the components may be combined directly with another component of the gypsum slurry.

Upon deposition of the gypsum slurry, and as previously disclosed, the calcium sulfate hemihydrate of the stucco may react with the water to hydrate the calcium sulfate hemihydrate into calcium sulfate dihydrate. Such reaction may allow for the gypsum to set and become firm thereby allowing for the panels to be cut at the desired length. In this regard, the method may comprise a step of reacting calcium sulfate hemihydrate with water to form calcium sulfate dihydrate or allowing the calcium sulfate hemihydrate to hydrate to calcium sulfate dihydrate. In this regard, the method may allow for the slurry to set to form a gypsum panel. In addition, during this process, the method may allow for dewatering of the gypsum slurry, in particular dewatering any free water instead of combined water of the gypsum slurry. Thereafter, the method may also comprise a step of cutting a continuous gypsum sheet into a gypsum panel. Then, after the cutting step, the method may comprise a step of supplying the gypsum panel to a heating or drying device. For instance, such a heating or drying device may be a kiln and may allow for removal (e.g., evaporation) of any free water. It should be understood that this heating or drying device may be different from the device used to heat stucco to form a first stucco composition. The temperature and time required for drying in such drying device are not necessarily limited by the present disclosure.

In general, the gypsum core may comprise calcium sulfate dihydrate. The gypsum used to make the gypsum core may be from a natural source, a synthetic source, and/or from reclaim and is thus not necessarily limited by the present invention. In general, the gypsum, in particular the calcium sulfate dihydrate, may be present in the gypsum core in an amount of at least 50 wt. %, such as at least 60 wt. %, such as at least 70 wt. %, such as at least 80 wt. %, such as at least 90 wt. %, such as at least 95 wt. %, such as at least 98 wt. %, such as at least 99 wt. %. The gypsum may be present in an amount of 100 wt. % or less, such as 99 wt. % or less, such as 98 wt. % or less, such as 95 wt. % or less, such as 90 wt. % or less based on the weight of the solids in the gypsum slurry. In one embodiment, the aforementioned weight percentages are based on the weight of the gypsum core. In another embodiment, the aforementioned weight percentages are based on the weight of the gypsum panel.

In some aspects, the gypsum core may also comprise other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

In general, the composition of the gypsum core is not necessarily limited and may include any additives as known in the art. For instance, the additives may include dispersants, foam or foaming agents, set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum core may be present in the gypsum core in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer.

In some aspects, the gypsum core is sandwiched by facing materials. The facing material may be any facing material as generally employed in the art. For instance, the facing material may be a paper facing material, a fibrous (e.g., glass fiber) mat facing material, or a polymeric facing material. In general, the first facing material and the second facing material may be the same type of material. Alternatively, the first facing material may be one type of material while the second facing material may be a different type of material.

In one embodiment, the facing material may include a paper facing material. For instance, both the first and second facing materials may be a paper facing material. Alternatively, in another embodiment, the facing material may be a glass mat facing material. For instance, both the first and second facing materials may be a glass mat facing material. In a further embodiment, the facing material may be a polymeric facing material. For instance, both the first and second facing materials may be a polymeric facing material. In another further embodiment, the facing material may be a metal facing material (e.g., an aluminum facing material). For instance, both the first and second facing materials may be a metal facing material (e.g., an aluminum facing material).

The glass mat facing material in one embodiment may be coated. However, in one particular embodiment, the glass mat facing material may not have a coating, such as a coating that is applied to the surface of the mat.

In general, a gypsum panel formed in accordance with the present disclosure may be formed from a method as disclosed herein. For instance, in the method of making a gypsum panel, a first facing material may be provided wherein the first facing material has a first facing material surface and a second facing material surface opposite the first facing material surface. The first facing material may be conveyed on a conveyor system (i.e., a continuous system for continuous manufacture of gypsum panel). Thereafter, a gypsum slurry may be provided or deposited onto the first facing material in order to form and provide a gypsum core. Next, a second facing material may be provided onto the gypsum slurry. The first facing material, the gypsum core, and the second facing material may then be dried simultaneously. Next, the first facing material, the gypsum core, and the second facing material may be cut such that the first facing material, the gypsum core, and the second facing material form a gypsum panel.

In general, the composition of the gypsum slurry and gypsum core is not necessarily limited and may be any generally known in the art. Generally, in one embodiment, the gypsum core is made from a gypsum slurry including at least stucco and water. However, as indicated herein, the gypsum slurry may include a second stucco composition and/or one or more components of a coating composition. In this respect, the second stucco composition may be added to the gypsum slurry at any point in the process of forming the gypsum panel. Further, any optional additives as indicated herein may also be added to the gypsum slurry.

In general, stucco may be referred to as calcined gypsum or calcium sulfate hemihydrate. The calcined gypsum may be from a natural source, a synthetic source, or reclaim and is thus not necessarily limited by the present invention. In addition to the stucco, the gypsum slurry may also contain some calcium sulfate dihydrate or calcium sulfate anhydrite. If calcium sulfate dihydrate is present, the hemihydrate is present in an amount of at least 50 wt. %, such as at least 60 wt. %, such as at least 70 wt. %, such as at least 80 wt. %, such as at least 85 wt. %, such as at least 90 wt. %, such as at least 95 wt. %, such as at least 98 wt. %, such as at least 99 wt. % based on the weight of the calcium sulfate hemihydrate and the calcium sulfate dihydrate. Furthermore, the calcined gypsum may be anhydrite (e.g., AII, AIII), α-hemihydrate, β-hemihydrate, or a mixture thereof.

In addition to the stucco, the gypsum slurry may also contain other cementitious materials. These cementitious materials may include calcium sulfate anhydrite, land plaster, cement, fly ash, or any combination thereof. When present, they may be utilized in an amount of 30 wt. % or less, such as 25 wt. % or less, such as 20 wt. % or less, such as 15 wt. % or less, such as 10 wt. % or less, such as 8 wt. % or less, such as 5 wt. % or less based on the total content of the cementitious material.

As indicated above, the gypsum slurry may include water. Water may be employed for fluidity and hydration of the calcined gypsum to allow for setting.

The weight ratio of the water to the stucco may be 0.1 or more, such as 0.2 or more, such as 0.2 or more, such as 0.3 or more, such as 0.4 or more, such as 0.5 or more, such as 0.6 or more, such as 0.7 or more. The water to stucco weight ratio may be 4 or less, such as 3.5 or less, such as 3 or less, such as 2.5 or less, such as 2 or less, such as 1.7 or less, such as 1.5 or less, such as 1.4 or less, such as 1.3 or less, such as 1.2 or less, such as 1.1 or less, such as 1 or less, such as 0.9 or less, such as 0.85 or less, such as 0.8 or less, such as 0.75 or less, such as 0.7 or less, such as 0.6 or less, such as 0.5 or less, such as 0.4 or less, such as 0.35 or less, such as 0.3 or less, such as 0.25 or less, such as 0.2 or less.

In addition to the stucco and the water, the gypsum slurry may also include any other conventional additives as known in the art. In this regard, such additives are not necessarily limited by the present invention. For instance, the additives may include dispersants, foam or foaming agents including aqueous foam (e.g. sulfates), set accelerators (e.g., ball mill accelerator, land plaster, sulfate salts, etc.), set retarders, binders, biocides (such as bactericides and/or fungicides), adhesives, pH adjusters, thickeners (e.g., silica fume, Portland cement, fly ash, clay, celluloses, high molecular weight polymers, etc.), leveling agents, non-leveling agents, colorants, fire retardants or additives (e.g., silica, silicates, expandable materials such as vermiculite, perlite, etc.), water repellants (e.g., waxes, silicones, siloxanes, etc.), fillers (e.g., glass spheres, glass fibers), natural and synthetic fibers (e.g. cellulosic fibers, microfibrillated fibers, nanocellulosic fibers, etc.), acids (e.g., boric acid), secondary phosphates (e.g., condensed phosphates or orthophosphates including trimetaphosphates, polyphosphates, and/or cyclophosphates, etc.) and/or other phosphate derivatives (e.g., fluorophosphates, etc.), natural and synthetic polymers, starches (e.g., pregelatinized starch, non-pregelatinized starch, and/or a modified starch, such as an acid modified starch), dextrose, sound dampening polymers (e.g., viscoelastic polymers/glues, such as those including an acrylic/acrylate polymer, etc.; polymers with low glass transition temperature, etc.), and mixtures thereof. In general, it should be understood that the types and amounts of such additives are not necessarily limited by the present invention.

Each additive of the gypsum slurry may be present in the gypsum slurry in an amount of 0.0001 wt. % or more, such as 0.001 wt. % or more, such as 0.01 wt. % or more, such as 0.02 wt. % or more, such as 0.05 wt. % or more, such as 0.1 wt. % or more, such as 0.15 wt. % or more, such as 0.2 wt. % or more, such as 0.25 wt. % or more, such as 0.3 wt. % or more, such as 0.5 wt. % or more, such as 1 wt. % or more, such as 2 wt. % or more. The additive may be present in an amount of 20 wt. % or less, such as 15 wt. % or less, 10 wt. % or less, such as 7 wt. % or less, such as 5 wt. % or less, such as 4 wt. % or less, such as 3 wt. % or less, such as 2.5 wt. % or less, such as 2 wt. % or less, such as 1.8 wt. % or less, such as 1.5 wt. % or less, such as 1 wt. % or less, such as 0.8 wt. % or less, such as 0.6 wt. % or less, such as 0.5 wt. % or less, such as 0.4 wt. % or less, such as 0.35 wt. % or less, such as 0.3 wt. % or less, such as 0.2 wt. % or less, such as 0.15 wt. % or less. The weight percentage may be based on the weight of the gypsum panel. Further, the weight percentage may be based on the weight of the gypsum core. In a further embodiment, such weight percentage may be based on the weight of a respective gypsum core layer. In an even further embodiment, the aforementioned weight percentages may be based on the solids content of the gypsum slurry. Moreover, the aforementioned weight percentages may be based on the weight of the stucco in the gypsum slurry. Additionally, the aforementioned weight percentages may be based on the weight of the gypsum in the gypsum core. In yet another embodiment, the aforementioned weight percentages may be based on the weight of the gypsum in the respective gypsum core layer.

The foaming agent may be one generally utilized in the art. For instance, the foaming agent may include an alkyl sulfate, an alkyl ether sulfate, or a mixture thereof. In one embodiment, the foaming agent includes an alkyl sulfate. In another embodiment, the foaming agent includes an alkyl ether sulfate. In a further embodiment, the foaming agent includes an alkyl sulfate without an alkyl ether sulfate. In an even further embodiment, the foaming agent includes a mixture of an alkyl sulfate and an alkyl ether sulfate. When a mixture is present, the alkyl ether sulfate may be present in an amount of 30 wt. % or less, such as 20 wt. % or less, such as 10 wt. % or less, such as 9 wt. % or less, such as 8 wt. % or less, such as 7 wt. % or less, such as 6 wt. % or less, such as 5 wt. % or less, such as 4 wt. % or less, such as 3 wt. % or less, such as 2 wt. % or less based on the combined weight of the alkyl sulfate and the alkyl ether sulfate. In addition, the alkyl ether sulfate may be present in an amount of 0.01 wt. % or more, such as 0.1 wt. % or more, such as 0.2 wt. % or more, such as 0.3 wt. % or more, such as 0.5 wt. % or more, such as 1 wt. % or more, such as 1.5 wt. % or more, such as 2 wt. % or more, such as 2.5 wt. % or more, such as 3 wt. % or more, such as 4 wt. % or more, such as 5 wt. % or more, such as 10 wt. % or more, such as 20 wt. % or more, based on the combined weight of the alkyl sulfate and the alkyl ether sulfate.

As indicated, the foaming agent may include a combination of an alkyl sulfate and an alkyl ether sulfate. In this regard, the weight ratio of the alkyl sulfate to the alkyl ether sulfate may be 2 or more, such as 4 or more, such as 5 or more, such as 10 or more, such as 15 or more, such as 20 or more, such as 25 or more, such as 30 or more, such as 40 or more, such as 50 or more, such as 60 or more, such as 70 or more, such as 80 or more, such as 90 or more, such as 95 or more. The weight ratio may be less than 100, such as 99 or less, such as 98 or less, such as 95 or less, such as 90 or less, such as 85 or less, such as 80 or less, such as 75 or less, such as 70 or less, such as 60 or less, such as 50 or less, such as 40 or less, such as 30 or less, such as 20 or less, such as 15 or less, such as 10 or less, such as 8 or less, such as 5 or less, such as 4 or less.

In another aspect, the alkyl ether sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl ether sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

Additionally, in some aspects, the alkyl sulfate may be present in the foaming agent in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less. The alkyl sulfate may be present in the foaming agent in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more.

In some aspects, the foaming agent may include one or more foam stabilizers, such as ethoxylated glycerin. The one or more foam stabilizers may be present in the gypsum slurry and/or gypsum core in an amount of 100 wt. % or less, such as 90 wt. % or less, such as 80 wt. % or less, such as 70 wt. % or less, such as 60 wt. % or less, such as 50 wt. % or less, such as 40 wt. % or less, such as 30 wt. % or less, such as 20 wt. % or less, such as 10 wt. % or less, such as 5 wt. % or less by weight of the foaming agent. The one or more foam stabilizers may be present in the gypsum slurry and/or gypsum core in an amount of 0.01 wt. % or more, such as 5 wt. % or more, such as 10 wt. % or more, such as 20 wt. % or more, such as 30 wt. % or more, such as 40 wt. % or more, such as 50 wt. % or more, such as 60 wt. % or more, such as 70 wt. % or more, such as 80 wt. % or more, such as 90 wt. % or more by weight of the foaming agent.

By utilizing a soap, foaming agent, and/or foam as disclosed herein, the gypsum slurry may include bubbles or voids having a particular size. Such size may then contribute to the void structure in the gypsum panel and the resulting properties. In this regard, the gypsum slurry may have bubbles or voids having a median size of 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1,000 microns or more. The gypsum slurry may have bubbles or voids having a median size of 1,400 microns or less, such as 1,300 microns or less, such as 1,200 microns or less, such as 1,100 microns or less, such as 1,000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 100 microns or less. Furthermore, while the aforementioned references a median size, it should be understood that in another embodiment, such size may also refer to an average size.

In some aspects, the foam may be provided in an amount of 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

The foam may comprise water and a foaming agent. In some aspects, the foaming agent may be provided in an amount of 0.05 lbs/MSF or more, such as 0.25 lbs/MSF or more, such as 0.5 lbs/MSF or more, such as 0.75 lbs/MSF or more, such as 1 lb/MSF or more, such as 2 lbs/MSF or more, such as 3 lbs/MSF or more, such as 4 lbs/MSF or more. The foaming agent may be provided in an amount of 5 lbs/MSF or less, such as 4 lbs/MSF or less, such as 3 lbs/MSF or less, such as 2 lbs/MSF or less, such as 1 lb/MSF or less, such as 0.5 lbs/MSF or less, such as 0.25 lbs/MSF or less. Further, in some aspects, the water utilized in the foam may be provided in an amount of 70 lbs/MSF or more, such as 75 lbs/MSF or more, such as 100 lbs/MSF or more, such as 125 lbs/MSF or more, such as 150 lbs/MSF or more, such as 175 lbs/MSF or more, such as 200 lbs/MSF or more, such as 225 lbs/MSF or more, such as 250 lbs/MSF or more, such as 275 lbs/MSF or more, such as 300 lbs/MSF or more, such as 325 lbs/MSF or more. The water utilized in the foam may be provided in an amount of 350 lbs/MSF or less, such as 325 lbs/MSF or less, such as 300 lbs/MSF or less, such as 275 lbs/MSF or less, such as 250 lbs/MSF or less, such as 225 lbs/MSF or less, such as 200 lbs/MSF or less, such as 175 lbs/MSF or less, such as 150 lbs/MSF or less, such as 125 lbs/MSF or less, such as 100 lbs/MSF or less.

In some aspects, the foaming agent may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The foaming agent may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In some aspects, the gypsum slurry and/or gypsum core may include one or more dispersants. The dispersant is not necessarily limited and may include any that can be utilized within the gypsum slurry. The dispersant may include carboxylates, sulfates, sulfonates, phosphates, mixtures thereof, etc.

In one embodiment, the dispersant may include a carboxylate, such as a carboxylate ether and in particular a polycarboxylate ether or a carboxylate ester and in particular a polycarboxylate ester.

In a further embodiment, the dispersant may include a sulfonate, such as a naphthalene sulfonate, a naphthalene sulfonate formaldehyde condensate, a sodium naphthalene sulfonate formaldehyde condensate, a lignosulfonate, a melamine formaldehyde condensate, or a mixture thereof.

In another embodiment, the dispersant may include a phosphate. For instance, the phosphate dispersant may be a polyphosphate dispersant, such as sodium trimetaphosphate, sodium tripolyphosphate, potassium tripolyphosphate, tetrasodium pyrophosphate, tetrapotassium pyrophosphate, tetrapotassium pyrophosphate, or a mixture thereof. In one embodiment, the polyphosphate dispersant may be sodium trimetaphosphate. In one embodiment, the phosphate may be sodium monofluorophosphate.

In this regard, the dispersant may include a sulfonate, a polycarboxylate ether, a polycarboxylate ester, or a mixture thereof. In one embodiment, the dispersant may include a sulfonate. In another embodiment, the dispersant may include a polycarboxylate ether. In a further embodiment, the dispersant may include a polycarboxylate ester.

In some aspects, the dispersant may be provided in an amount of 0.01 lbs/MSF or more, such as 0.5 lbs/MSF or more, such as 1 lb/MSF or more, such as 2 lbs/MSF or more, such as 5 lbs/MSF or more, such as 8 lbs/MSF or more, such as 10 lbs/MSF or more, such as 15 lbs/MSF or more, such as 20 lbs/MSF or more, such as 25 lbs/MSF or more, such as 30 lbs/MSF or more, such as 35 lbs/MSF or more. The dispersant may be provided in an amount of 40 lbs/MSF or less, such as 35 lbs/MSF or less, such as 30 lbs/MSF or less, such as 25 lbs/MSF or less, such as 20 lbs/MSF or less, such as 15 lbs/MSF or less, such as 10 lbs/MSF or less, such as 8 lbs/MSF or less, such as 5 lbs/MSF or less, such as 2 lbs/MSF or less, such as 1 lb/MSF or less.

In some aspects, the dispersant may be provided in an amount of 0.5 lbs/ft³ or more, such as 1 lb/ft³ or more, such as 1.5 lbs/ft³ or more, such as 2 lbs/ft³ or more, such as 2.5 lbs/ft³ or more, such as 3 lbs/ft³ or more, such as 3.5 lbs/ft³ or more, such as 4 lbs/ft³ or more, such as 4.5 lbs/ft³ or more, such as 5 lbs/ft³ or more. The dispersant may be provided in an amount of 25 lbs/ft³ or less, such as 20 lbs/ft³ or less, such as 15 lbs/ft³ or less, such as 13 lbs/ft³ or less, such as 11 lbs/ft³ or less, such as 10 lbs/ft³ or less, such as 9 lbs/ft³ or less, such as 8 lbs/ft³ or less, such as 7 lbs/ft³ or less, such as 6 lbs/ft³ or less. Notably, the aforementioned values may be based on the gypsum core.

In some aspects, the gypsum slurry and/or gypsum core may include one or more surfactants. In general, the surfactant may be an anionic surfactant, a cationic surfactant, a non-ionic surfactant, a fluorinated surfactant, a silicon surfactant, or a mixture thereof. Generally, a surfactant may be in the form of a solid, a liquid, or a combination thereof.

As indicated above, in one embodiment, the surfactant may include an anionic surfactant. In general, anionic surfactants include those having one or more negatively charged functional groups. For instance, the anionic surfactant may include an alkali metal or ammonium salts of alkyl, aryl or alkylaryl sulfonates, sulfates, or a mixture thereof. In some aspects, the anionic surfactant may include ammonium lauryl sulfate, sodium lauryl sulfate, sodium octylphenol glycolether sulfate, sodium laureth sulfate, sodium myreth sulfate, sodium dodecylbenzene sulfonate, perfluorobutane sulfonate, dodecyl benzene sulfonate, alpha-olefin sulfonate, sodium lauryldiglycol sulfate, ammonium tritertiarybutyl phenol and penta- and octa-glycol sulfonates, sulfosuccinate salts such as disodium ethoxylated nonylphenol half ester of sulfosuccinic acid, disodium n-octyldecyl sulfosuccinate, sodium dioctyl sulfosuccinate, alpha olefin sulfonate and/or olefin sulfonate (e.g., sodium olefin sulfonates, such as sodium C14-C16 olefin sulfonate, sodium C14-C18 olefin sulfonate, and sodium C16-C18 olefin sulfonate), and mixtures thereof. Other examples include a C₈-C₂₂ alkyl fatty acid salt of an alkali metal, alkaline earth metal, ammonium, alkyl substituted ammonium, for example, isopropylamine salt, or alkanolammonium salt, a C₈-C₂₂ alkyl fatty acid ester, a C₈-C₂₂ alkyl fatty acid ester salt, and alkyl ether carboxylates. Further, the anionic surfactant may include a phosphate (alkyl-aryl ether phosphates, alkyl ether phosphates, etc.), a phosphite, a phosphonate, a carboxylate (e.g., sodium stearate, etc.), or a mixture thereof.

In one particular embodiment, the anionic surfactant may include a water-soluble salt, particularly an alkali metal salt, of an organic sulfur reaction product having in their molecular structure an alkyl radical containing from about 8 to 22 carbon atoms and a radical selected from the group consisting of sulfonic and sulfuric acid ester radicals. Organic sulfur based anionic surfactants include the salts of C₁₀-C₁₆ alkylbenzene sulfonates, C₁₀-C₂₂ alkane sulfonates, C₁₀-C₂₂ alkyl ether sulfates, C₁₀-C₂₂ alkyl sulfates, C₄-C₁₀ dialkylsulfosuccinates, C₁₀-C₂₂ acyl isothionates, alkyl diphenyloxide sulfonates, alkyl naphthalene sulfonates, C₁₀-C₂₀ alpha olefin sulfonates, and 2-acetamido hexadecane sulfonates. In some aspects, the anionic surfactant may include C₆-C₁₂ linear and/or branched alkyl sulfates and/or C₆-C₁₂ linear and/or branched alkyl ether sulfates. Organic phosphate based anionic surfactants include organic phosphate esters such as complex mono- or diester phosphates of hydroxyl-terminated alkoxide condensates, or salts thereof. Included in the organic phosphate esters are phosphate ester derivatives of polyoxyalkylated alkylaryl phosphate esters, of ethoxylated linear alcohols and ethoxylates of phenol. Particular examples of anionic surfactants include a polyoxyethylene alkyl ether sulfuric ester salt, a polyoxyethylene alkylphenyl ether sulfuric ester salt, polyoxyethylene styrenated alkylether ammonium sulfate, polyoxymethylene alkylphenyl ether ammonium sulfate, and the like, and mixtures thereof. For instance, the anionic surfactant may include a polyoxyethylene alkyl ether sulfuric ester salt, a polyoxyethylene alkylphenyl ether sulfuric ester salt, or a mixture thereof. In some aspects, the anionic surfactant may include sulfated alkanolamide, glyceride sulfate, or a mixture thereof.

As indicated above, in one embodiment, the surfactant may include a non-ionic surfactant. In some aspects, the nonionic surfactant may be an amine oxide. In some aspects, the nonionic surfactant may be an ethoxylate. For instance, the nonionic surfactant may be an ethoxylated fatty alcohol, a linear alcohol ethoxylate (e.g., narrow-range ethoxylate, octaethylene glycol monododecyl ether, pentaethylene glycol monododecyl ether, etc.), an alkylphenol ethoxylate (e.g., a nonoxynol, octylphenol ethoxylate, etc.), a fatty acid ethoxylate, an ethoxylated fatty ester, or an ethoxylated amine. In some aspects, the nonionic surfactant may be and/or include fatty acid amides (e.g., polyethoxylated tallow amine, cocamide monoethanolamine, cocamide diethanolamine, etc.), fatty acid esters of glycerol (e.g., glycerol monostearate, glycerol monolaurate, etc.), fatty acid esters of sorbitol (e.g., sorbitan monolaurate, sorbitan monostearate, sorbitan tristearate, etc.), alkyl polyglycosides (e.g., decyl glucoside, lauryl glucoside, octyl glucoside, etc.), block copolymers of polyethylene glycol and polypropylene glycol, glycerol alkyl esters, alkyl polyglucosides, polyoxyethylene glycol octylphenol ethers, sorbitan alkyl esters, polyoxyethylene glycol sorbitan alkyl esters, and mixtures thereof. For instance, the non-ionic surfactant may include a polyethylene oxide condensate of an alkyl phenol (e.g., the condensation product of an alkyl phenol having an alkyl group containing from 6 to 12 carbon atoms in either a straight chain or branched chain configuration, with ethylene oxide (e.g., present in amounts equal to 1 to 40 moles)). The alkyl substituent may be derived, for example, from polymerized propylene, di-isobutylene, octane or nonene. Other examples include dodecylphenol condensed with 12 moles of ethylene oxide per mole of phenol; dinonylphenol condensed with 5 moles of ethylene oxide per mole of phenol; nonylphenol condensed with 9 moles of ethylene oxide per mole of nonylphenol and di-iso-octylphenol condensed with 5 moles of ethylene oxide. The non-ionic surfactant may be a condensation product of a primary or secondary aliphatic alcohol having from 8 to 24 carbon atoms, in either straight chain or branched chain configuration, with from 1 to about 40 moles of alkylene oxide per mole of alcohol. The non-ionic surfactant may include a compound formed by condensing ethylene oxide with a hydrophobic base formed by the condensation of propylene oxide with propylene glycol (e.g., Pluronics). In one embodiment, the surfactant may be a silicon surfactant such as a polyether-modified siloxane.

In some aspects, a surfactant may include an ethoxylated alcohol that may include carbon chain lengths ranging from 12 to 20 carbon atoms. For instance, an ethoxylated alcohol may include carbon chain lengths ranging from 12 to 20 carbon atoms. A surfactant may include a blend of ethoxylated alcohols that have carbon chain lengths ranging from 12 to 20 carbon atoms. For instance, surfactant may include a blend of ethoxylated alcohols having carbon chain lengths ranging from 12 to 20 carbon atoms.

In one embodiment, the surfactant may include a cationic surfactant. For instance, the surfactant may include a cationic surfactant such as water-soluble quaternary ammonium compounds, polyammonium salts, a polyoxyethylene alkylamine and the like. In some aspects, the surfactant may include a cationic surfactant such as a quaternary ammonium salt (e.g., cetrimonium bromide, cetylpyridinium chloride, benzalkonium chloride, benzethonium chloride, dimethyldioctadecylammonium chloride, and dioctadecyldimethylammonium bromide, etc.).

In some aspects, the gypsum slurry and/or gypsum core may include one or more starches. The starch may be one generally utilized in the art. Such starch may be combined with the stucco and water. In this regard, such starch may be present in the gypsum slurry as well as the resulting gypsum core and gypsum panel. In some aspects, one or more components of a gypsum panel may be free of starch. For instance, the gypsum core and/or gypsum slurry may be free of starch. In some aspects, a gypsum panel formed in accordance with the present disclosure may be free of starch.

The starch may be a corn starch, a wheat starch, a milo starch, a potato starch, a rice starch, an oat starch, a barley starch, a cassava starch, a tapioca starch, a pea starch, a rye starch, an amaranth starch, or other commercially available starch. For example, in one embodiment, the starch may be a corn starch. In another embodiment, the starch may be a wheat starch. In an even further embodiment, the starch may be a milo starch.

Furthermore, the starch may be an unmodified starch or a modified starch. In one embodiment, the starch may be a modified starch. In another embodiment, the starch may be an unmodified starch. In an even further embodiment, the starch may be a mixture of a modified starch and an unmodified starch.

As indicated above, in one embodiment, the starch may be an unmodified starch. For instance, the starch may be a pearl starch (e.g., an unmodified corn starch). In addition, in one embodiment, the starch may also be a non-migrating starch. Also, with respect to gelatinization, the starch may be a non-pregelatinized starch.

As also indicated above, in another embodiment, the starch may be a modified starch. Such modification may be any as typically known in the art and is not necessarily limited. For instance, the modification may be via a physical, enzymatic, or chemical treatment. In one embodiment, the modification may be via a physical treatment. In another embodiment, the modification may be via an enzymatic treatment. In a further embodiment, the modification may be via a chemical treatment. The starch may be treated using many types of reagents. For example, the modification can be conducted using various chemicals, such as inorganic acids (e.g., hydrochloric acid, phosphorous acid or salts thereof, etc.), peroxides (e.g., sodium peroxide, potassium peroxide, hydrogen peroxide, etc.), anhydrides (e.g., acetic anhydride), etc. to break down the starch molecule.

In this regard, in one embodiment, the starch may be a pregelatinized starch, an acid-modified (or hydrolyzed) starch, an extruded starch, an oxidized starch, an oxyhydrolyzed starch, an ethoxylated starch, an ethylated starch, an acetylated starch, a mixture thereof, etc. For example, in one embodiment, the starch may be a pregelatinized starch. In another embodiment, the starch may be an acid-modified (or hydrolyzed) starch. In a further embodiment, the starch may be an extruded starch. In another embodiment, the starch may be an oxidized starch. In a further embodiment, the starch may be an oxyhydrolyzed starch. In another further embodiment, the starch may be an ethoxylated starch. In another embodiment, the starch may be an ethylated starch. In a further embodiment, the starch may be an acetylated starch.

In one embodiment, the starch may be a pregelatinized starch. In this regard, the starch may have been exposed to water and heat for breaking down a certain degree of intermolecular bonds within the starch. As an example and without intending to be limited by theory, during heating, water is absorbed into the amorphous regions of the starch thereby allowing it to swell. Then amylose chains may begin to dissolve resulting in a decrease in the crystallinity and an increase in the amorphous form of the starch.

In another embodiment, the starch may be an acid-modified starch. Such acid modification can be conducted using various chemicals, such as inorganic acids (e.g., hydrochloric acid, phosphorous acid or salts thereof, etc.) to break down the starch molecule. Furthermore, by utilizing acid-modification, the starch may result in a low thinned starch, a medium thinned starch, or a high thinned starch. For example, a higher degree of modification can result in a lower viscosity starch while a lower degree of modification can result in a higher viscosity starch. The degree of modification and resulting viscosity may also affect the degree of migration of the starch. For instance, when presented within the core of the gypsum panel, a higher degree of modification and lower viscosity may provide a high migrating starch while a lower degree of modification and higher viscosity may provide a low migrating starch.

The starch may also have a particular gelling temperature. Without intending to be limited, this temperature is the point at which the intermolecular bonds of the starch are broken down in the presence of water and heat allowing the hydrogen bonding sites to engage more water. In this regard, the gelling temperature may be 60° C. or more, such as 80° C. or more, such as 100° C. or more. The gelling temperature may be 120° C. or less, such as 100° C. or less, such as 80° C. or less. In one embodiment, the aforementioned may refer to a peak gelling temperature.

As indicated above, the starch may have a particular gelling temperature. Without intending to be limited by theory, acid modification may provide a starch having a relatively lower gelling temperature. Meanwhile, without intending to be limited by theory, modifications of the hydroxyl group, such as by replacement via ethoxylation, ethylation, oxidation, or acetylation may provide a relatively lower gelling temperature or a reduction in gelling temperature. In this regard, in some embodiments, the starch may be acid-modified and chemically modified wherein the hydroxyl groups are substituted.

In one embodiment, the starch may be an extruded starch. For example, the extrusion may provide a thermomechanical process that can break the intermolecular bonds of the starch. Such extrusion may result in the gelatinization of starch due to an increase in the water absorption.

In another embodiment, the starch may be an oxidized starch. For example, the starch may be oxidized using various means known in the art. This may include, but is not limited to, chemical treatments utilizing oxidizing agents such as chlorites, chlorates, perchlorates, hypochlorites (e.g., sodium hypochlorite, etc.), peroxides (e.g., sodium peroxide, potassium peroxide, hydrogen peroxide, etc.), etc. In general, during oxidation, the molecules are broken down yielding a starch with a decreased molecular weight and a reduction in viscosity.

Also, it should be understood that the starch may include a combination of starches, such as any of those mentioned above. For instance, it should be understood that the starch may include more than one different starch. In addition, any combination of modifications may also be utilized to form the starch utilized according to the present invention.

In some aspects, the starch may be present in an amount of 0.001 lbs/MSF or more, such as 0.01 lbs/MSF or more, such as 0.05 lbs/MSF or more, such as 0.1 lbs/MSF or more, such as 0.2 lbs/MSF or more, such as 0.25 lbs/MSF or more, such as 0.5 lbs/MSF or more, such as 0.75 lbs/MSF or more, such as 1 lb/MSF or more, such as 1.5 lbs/MSF or more, such as 2 lbs/MSF or more, such as 2.5 lbs/MSF or more, such as 3 lbs/MSF or more, such as 4 lbs/MSF or more, such as 5 lbs/MSF or more, such as 8 lbs/MSF or more, such as 10 lbs/MSF or more, such as 15 lbs/MSF or more, such as 20 lbs/MSF or more. The starch may be present in an amount of 50 lbs/MSF or less, such as 30 lbs/MSF or less, such as 25 lbs/MSF or less, such as 20 lbs/MSF or less, such as 15 lbs/MSF or less, such as 10 lbs/MSF or less, such as 5 lbs/MSF or less, such as 4 lbs/MSF or less, such as 3 lbs/MSF or less, such as 2.5 lbs/MSF or less, such as 2 lbs/MSF or less, such as 1.5 lbs/MSF or less, such as 1 lb/MSF or less.

In one embodiment, the gypsum core may include a first gypsum core layer and a second gypsum core layer. The first gypsum core layer may be between the first facing material (e.g., front of the panel) and the second gypsum core layer. In addition, the first gypsum core layer may have a density greater than the second gypsum core layer. Accordingly, the first gypsum core layer may be formed using a gypsum slurry without the use of a foaming agent and/or foam or with a reduced amount of foaming agent and/or foam, which may be utilized in forming the second gypsum core layer. In this regard, in one embodiment, the first gypsum core layer may have the same composition as the second gypsum core layer except that the second gypsum core layer may be formed using a foaming agent and/or foam or a greater amount of foaming agent and/or foam.

In one embodiment, the gypsum core may also include a third gypsum core layer. The third gypsum core layer may be provided between the second gypsum core layer and a second facing material (e.g., back of the panel). In some aspects, the third gypsum core layer may be located adjacent to the second facing material. Like the first gypsum core layer, the third gypsum core layer may also be a dense gypsum core layer. In particular, the third gypsum core layer may have a density greater than the second gypsum core layer. Accordingly, the third gypsum core layer may be formed using a gypsum slurry without the use of a foaming agent and/or foam or with a reduced amount of foaming agent and/or foam, which may be utilized in forming the second gypsum core layer. In this regard, in one embodiment, the third gypsum core layer may have the same composition as the second gypsum core layer except that the second gypsum core layer may be formed using a foaming agent and/or foam or a greater amount of foaming agent and/or foam.

When the gypsum core includes multiple gypsum core layers, the gypsum slurry may be deposited in multiple steps for forming the gypsum core. For instance, each gypsum core layer may require a separate deposition of gypsum slurry. In this regard, with a first gypsum core layer and a second gypsum core layer, a first gypsum slurry may be deposited followed by a second gypsum slurry. The first gypsum slurry and the second gypsum slurry may have the same composition except that the second gypsum slurry may include a foaming agent and/or foam or more foaming agent and/or foam than the first gypsum slurry. In this regard, in one embodiment, the first gypsum slurry may not include a foaming agent and/or foam. Accordingly, the first gypsum slurry may result in a dense gypsum core layer, in particular a non-foamed gypsum core layer. Such gypsum core layer may have a density greater than the gypsum core layer formed from the second gypsum slurry, or foamed gypsum core layer.

Similarly, when the gypsum core includes three gypsum core layers, the gypsum slurry may be deposited in three steps for forming the gypsum core. For example, a first and second gypsum slurry may be deposited as indicated above and a third gypsum slurry may be deposited onto the second gypsum slurry. The third gypsum slurry and the second gypsum slurry may have the same composition except that the second gypsum slurry may include a foaming agent and/or foam or more foaming agent and/or foam than the third gypsum slurry. In this regard, in one embodiment, the third gypsum slurry may not include a foaming agent and/or foam. Accordingly, the third gypsum slurry may result in a dense gypsum core layer, in particular a non-foamed gypsum core layer. Such gypsum core layer may have a density greater than the gypsum core layer formed from the second gypsum slurry, or foamed gypsum core layer.

The first gypsum core layer may have a thickness that is 0.5% or more, such as 1% or more, such as 2% or more, such as 3% or more, such as 4% or more, such as 5% or more, such as 10% or more, such as 15% or more than the thickness of the second (or foamed) gypsum core layer. The thickness may be 80% or less, such as 60% or less, such as 50% or less, such as 40% or less, such as 30% or less, such as 25% or less, such as 20% or less, such as 15% or less, such as 10% or less, such as 8% or less, such as 5% or less the thickness of the second (or foamed) gypsum core layer. In one embodiment, such relationship may also be between the third gypsum core layer and the second gypsum core layer.

The density of the second (or foamed) gypsum core layer may be 0.5% or more, such as 1% or more, such as 2% or more, such as 3% or more, such as 4% or more, such as 5% or more, such as 10% or more, such as 15% or more the density of the first (or non-foamed) gypsum core layer. The density of the second (or foamed) gypsum core layer may be 80% or less, such as 60% or less, such as 50% or less, such as 40% or less, such as 30% or less, such as 25% or less, such as 20% or less, such as 15% or less, such as 10% or less, such as 8% or less, such as 5% or less the density of the first (or non-foamed) gypsum core layer. In one embodiment, such relationship may also be between the third gypsum core layer and the second gypsum core layer. In addition, in one embodiment, all of the gypsum core layers may have a different density.

Regardless of the above, any of the additives disclosed herein may be present in any combination of gypsum core layers. In some aspects, one or more gypsum core layers may comprise the same additive or additives. Further, in some aspects, the one or more gypsum core layers may comprise different additives. The different additives of the one or more gypsum core layers may be chosen such that it is advantageous to have a particular additive in one gypsum core layer and a different additive in another, different gypsum core layer.

The gypsum panel disclosed herein may have many applications. For instance, the gypsum panel may be used as a standalone panel in construction for the preparation of walls, ceilings, floors, roofs, etc. As used in the present disclosure, the term “gypsum panel,” generally refers to any panel, sheet, or planar structure, either uniform or formed by connected portions or pieces, that is constructed to at least partially establish one or more physical boundaries. Such existing, installed, or otherwise established or installed wall or ceiling structures comprise materials that may include, as non-limiting examples, gypsum, stone, ceramic, cement, wood, composite, or metal materials. The installed gypsum panel forms part of a building structure, such as a wall or ceiling.

In one embodiment, the gypsum panel may be processed such that any respective gypsum core layer may have an average void size of about 90 microns to about 1500 microns, such as about 90 microns or more, such as about 150 microns or more, such as about 200 microns or more, such as about 250 microns or more, such as about 300 microns or more, such as about 350 microns or more, such as about 400 microns or more, such as about 450 microns or more, such as about 500 microns or more. Generally, the average void size may be about 1,500 microns or less, such as about 1,300 microns or less, such as about 1,100 microns or less, such as about 1,000 microns or less, such as about 900 microns or less, such as about 800 microns or less, such as about 700 microns or less, such as about 600 microns or less, such as about 500 microns or less, such as about 400 microns or less, such as about 300 microns or less. In one embodiment, such core voids may reference any air voids due to voids generated from the use of a soap/foam. Furthermore, while the aforementioned references an average void size, it should be understood that in another embodiment, such size may also refer to a median void size.

The specific surface area of the gypsum core is not necessarily limited and may be from about 0.25 m²/g to about 5 m²/g. For instance, the specific surface area may be 0.25 m²/g or more, such as 0.5 m²/g or more, such as 1 m²/g or more, such as 1.5 m²/g or more, such as 2 m²/g or more, such as 2.5 m²/g or more, such as 3 m²/g or more, such as 3.5 m²/g or more, such as 4 m²/g or more. The specific surface area of the gypsum core may be 5 m²/g or less, such as 4 m²/g or less, such as 3.5 m²/g or less, such as 3 m²/g or less, such as 2.5 m²/g or less, such as 2 m²/g or less, such as 1.5 m²/g or less, such as 1 m²/g or less.

The thickness of the gypsum panel, and in particular, the gypsum core, is not necessarily limited and may be from about 0.25 inches to about 1 inch. For instance, the thickness may be at least ¼ inches, such as at least 5/16 inches, such as at least ⅜ inches, such as at least ½ inches, such as at least ⅝ inches, such as at least ¾ inches, such as at least 1 inch. In this regard, the thickness may be about any one of the aforementioned values. For instance, the thickness may be about ¼ inches. Alternatively, the thickness may be about ⅜ inches. In another embodiment, the thickness may be about ½ inches. In a further embodiment, the thickness may be about ⅝ inches. In another further embodiment, the thickness may be about 1 inch. In addition, at least two gypsum panels may be combined to create another gypsum panel, such as a composite gypsum panel. For example, at least two gypsum panels having a thickness of about 5/16 inches each may be combined or sandwiched to create a gypsum panel having a thickness of about ⅝ inches. While this is one example, it should be understood that any combination of gypsum panels may be utilized to prepare a sandwiched gypsum panel. With regard to the thickness, the term “about” may be defined as within 10%, such as within 5%, such as within 4%, such as within 3%, such as within 2%, such as within 1%. However, it should be understood that the present disclosure is not necessarily limited by the aforementioned thicknesses.

In addition, the panel weight of the gypsum panel is not necessarily limited. The gypsum panel may have a panel weight of about 500 lbs/MSF to about 7000 lbs/MSF including all increments of 1 lb/MSF therebetween. For instance, the gypsum panel may have a panel weight of 500 lbs/MSF or more, such as about 600 lbs/MSF or more, such as about 700 lbs/MSF or more, such as about 800 lbs/MSF or more, such as about 900 lbs/MSF or more, such as about 1000 lbs/MSF or more, such as about 1100 lbs/MSF or more, such as about 1200 lbs/MSF or more, such as about 1300 lbs/MSF or more, such as about 1400 lbs/MSF or more, such as about 1500 lbs/MSF or more. The panel weight may be about 7000 lbs/MSF or less, such as about 6000 lbs/MSF or less, such as about 5000 lbs/MSF or less, such as about 4000 lbs/MSF or less, such as about 3000 lbs/MSF or less, such as about 2500 lbs/MSF or less, such as about 2100 lbs/MSF or less, such as about 2000 lbs/MSF or less, such as about 1800 lbs/MSF or less, such as about 1600 lbs/MSF or less, such as about 1500 lbs/MSF or less, such as about 1400 lbs/MSF or less, such as about 1300 lbs/MSF or less, such as about 1200 lbs/MSF or less. Such panel weight may be a dry panel weight, such as after the panel leaves the heating or drying device (e.g., kiln).

In addition, the gypsum panel may have a density of about 15 pcf or more, such as about 20 pcf or more, such as about 25 pcf or more, such as about 28 pcf or more, such as about 30 pcf or more, such as about 33 pcf or more, such as about 35 pcf or more, such as about 38 pcf or more, such as about 40 pcf or more, such as about 43 pcf or more, such as about 45 pcf or more, such as about 48 pcf or more. The panel may have a density of about 60 pcf or less, such as about 50 pcf or less, such as about 40 pcf or less, such as about 35 pcf or less, such as about 33 pcf or less, such as about 30 pcf or less, such as about 28 pcf or less, such as about 25 pcf or less, such as about 23 pcf or less, such as about 20 pcf or less, such as about 18 pcf or less.

The gypsum panel may have a certain nail pull resistance, which generally is a measure of the force required to pull a gypsum panel off a wall by forcing a fastening nail through the panel. The values obtained from the nail pull test generally indicate the maximum stress achieved while the fastener head penetrates through the panel surface and core. In this regard, the gypsum panel exhibits a nail pull resistance of at least about 25 lb_{f}, such as at least about 30 pounds, such as at least about 35 lb_{f}, such as at least about 40 lb_{f}, such as at least about 45 lb_{f}, such as at least about 50 lb_{f}, such as at least about 55 lb_{f}, such as at least about 60 lb_{f}, such as at least about 65 lb_{f}, such as at least about 70 lb_{f}, such as at least about 75 lb_{f}, such as at least about 77 lb_{f}, such as at least about 80 lb_{f}, such as at least about 85 lb_{f}, such as at least about 90 lb_{f}, such as at least about 95 lb_{f}, such as at least about 100 lb_{f} as tested according to ASTM C1396-17. The nail pull resistance may be about 400 lb_{f} or less, such as about 300 lb_{f} or less, such as about 200 lb_{f} or less, such as about 150 Ibr or less, such as about 140 lb_{f} or less, such as about 130 lb_{f} or less, such as about 120 lb_{f} or less, such as about 110 Ibr or less, such as about 105 lb_{f} or less, such as about 100 lb_{f} or less, such as about 95 lb_{f} or less, such as about 90 lb_{f} or less, such as about 85 lb_{f} or less, such as about 80 lb_{f} or less as tested according to ASTM C1396-17. Such nail pull resistance may be based upon the thickness of the gypsum panel. For instance, when conducting a test, such nail pull resistance values may vary depending on the thickness of the gypsum panel. As an example, the nail pull resistance values above may be for a ⅝ inch panel. However, it should be understood that instead of a ⅝ inch panel, such nail pull resistance values may be for any other thickness gypsum panel as mentioned herein.

The gypsum panel may have a certain compressive strength. For instance, the compressive strength may be about 150 psi or more, such as about 200 psi or more, such as about 250 psi or more, such as about 300 psi or more, such as about 350 psi or more, such as about 375 psi or more, such as about 400 psi or more, such as about 500 psi or more as tested according to ASTM C473-19. The compressive strength may be about 3000 psi or less, such as about 2500 psi or less, such as about 2000 psi or less, such as about 1700 psi or less, such as about 1500 psi or less, such as about 1300 psi or less, such as about 1100 psi or less, such as about 1000 psi or less, such as about 900 psi or less, such as about 800 psi or less, such as about 700 psi or less, such as about 600 psi or less, such as about 500 psi or less. Such compressive strength may be based upon the density and thickness of the gypsum panel. For instance, when conducting a test, such compressive strength values may vary depending on the thickness of the gypsum panel. As an example, the compressive strength values above may be for a ⅝ inch panel. However, it should be understood that instead of a ⅝ inch panel, such compressive strength values may be for any other thickness gypsum panel as mentioned herein.

In addition, the gypsum panel may have a core hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f} as tested according to ASTM C1396-17. The gypsum panel may have a core hardness of 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17. In addition, the gypsum panel may have an end hardness according to the aforementioned values. Such core hardness may be based upon the thickness of the gypsum panel. For instance, when conducting a test, such core hardness values may vary depending on the thickness of the gypsum panel. As an example, the core hardness values above may be for a ⅝ inch panel. However, it should be understood that instead of a ⅝ inch panel, such core hardness values may be for any other thickness gypsum panel as mentioned herein.

In addition, the gypsum panel may have an edge hardness of at least about 8 lb_{f}, such as at least about 10 lb_{f}, such as at least about 11 lb_{f}, such as at least about 12 lb_{f}, such as at least about 15 lb_{f}, such as at least about 18 lb_{f}, such as at least about 20 lb_{f}, such as at least about 24 lb_{f}, such as at least about 28 lb_{f}, such as at least about 30 lb_{f}, such as at least about 33 lb_{f} as tested according to ASTM C1396-17 and ASTM C473-19. The gypsum panel may have an edge hardness of about 50 lb_{f} or less, such as about 40 lb_{f} or less, such as about 35 lb_{f} or less, such as about 30 lb_{f} or less, such as about 25 lb_{f} or less, such as about 20 lb_{f} or less, such as about 18 lb_{f} or less, such as about 15 lb_{f} or less as tested according to ASTM C1396-17 and ASTM C473-19. Such edge hardness may be based upon the thickness of the gypsum panel. For instance, when conducting a test, such edge hardness values may vary depending on the thickness of the gypsum panel. As an example, the edge hardness values above may be for a ⅝ inch panel. However, it should be understood that instead of a ⅝ inch panel, such edge hardness values may be for any other thickness gypsum panel as mentioned herein.

In addition, as previously disclosed, it may also be desired to have an effective bond between the facing material and the gypsum core. Typically, a humidified bond test is performed for 2 hours in a humidity chamber at 90° F. and 90% humidity. In this test, after exposure, the facing material is removed to determine how much remains on the gypsum panel. The percent coverage (or surface area) can be determined using various optical analytical techniques. In this regard, the facing material may cover 100% or less, such as less than 90%, such as less than 80%, such as less than 70%, such as less than 60%, such as less than 50%, such as less than 40%, such as less than 30%, such as less than 25%, such as less than 20%, such as less than 15%, such as less than 10%, such as less than 9%, such as less than 8% of the surface area of the gypsum core upon conducting the test. Such percentage may be for a face of the gypsum panel. Alternatively, such percentage may be for a back of the gypsum panel. Further, such percentages may apply to the face and the back of the gypsum panel. In addition, such values may be for an average of at least 3 gypsum panels, such as at least 5 gypsum panels.

Also, it may be desired to have a particular humidified deflection based on exposure in an atmosphere of 90° F.±3° F. and 90%±3% relative humidity for 48 hours. For instance, the humidified deflection may be 0.1 inches or less, such as 0.08 inches or less, such as 0.06 inches or less, such as 0.05 inches or less, such as 0.04 inches or less, such as 0.03 inches or less, such as 0.02 inches or less, such as 0.01 inches or less, such as 0.005 inches or less. The humified deflection may be 0 inches or more, such as 0.0001 inches or more, such as 0.0005 inches or more, such as 0.001 inches or more, such as 0.003 inches or more, such as 0.005 inches or more, such as 0.008 inches or more, such as 0.01 inches or more, such as 0.015 inches or more. Such values may be for an average of at least 3 gypsum panels.

### Plaster Composition

Notably, the second stucco composition may be incorporated into a plaster composition. In some aspects, a plaster composition may include the first stucco composition in addition to the second stucco composition.

In some aspects, the plaster composition may comprise a stucco composition (e.g., a first stucco composition, a second stucco composition) in an amount from about 20 wt. % to about 80 wt. %, including all increments of 0.01 wt. % therebetween. For instance, a stucco composition may be present in the plaster composition in an amount of about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more, such as about 60 wt. % or more, such as about 65 wt. % or more, such as about 70 wt. % or more, such as about 75 wt. % or more. A stucco composition may be present in the plaster composition in an amount of about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 45 wt. % or less, such as about 40 wt. % or less, such as about 35 wt. % or less, such as about 30 wt. % or less, such as about 25 wt. % or less.

In general, the plaster composition may also include one or more binders. The binder may include an acetate polymer, an acrylic polymer, a polyvinyl alcohol, a cellulose polymer, a starch, etc., or a combination thereof. In one embodiment, the binder may include two or more of an acetate polymer, an acrylic polymer, a polyvinyl alcohol, a cellulose polymer, or a starch. For instance, in one embodiment, the binder may include at least a mixture of an acetate polymer and a cellulose polymer. In a further embodiment, the binder may include at least an acetate polymer. In another further embodiment, the binder may include at least a cellulose polymer.

The acetate polymer may include a vinyl acetate, such as an ethylene vinyl acetate. For instance, the acetate polymer may be a polyvinyl acetate, a polyethylene vinyl acetate, or a mixture thereof. In one embodiment, the acetate polymer may include polyvinyl acetate. In another embodiment, the acetate polymer may include polyethylene vinyl acetate. In an even further embodiment, the acetate polymer may be a mixture of two acetate polymers, such as any two of the aforementioned.

The acrylic polymer may be any acrylic polymer. For instance, the acrylic polymer may be a polyacrylate. In a further embodiment, the acrylic polymer may be a polyvinyl acrylic polymer. In another further embodiment, the acrylic polymer may be a polyvinyl acetate acrylate. In an even further embodiment, the acrylic polymer may be a mixture of two acrylic polymers, such as any two of the aforementioned.

The cellulose polymer may include one or more cellulose ethers. In general, a cellulose ether may provide for enhanced workability and water retention. Notably, the cellulose ether may act as a thixotropic agent. The cellulose ether may include hydroxyl groups are partially or fully replaced by —OR groups, wherein R is a substituted or substituted alkyl. For instance, the alkyl may be a C₁-C₆ alkyl. In particular, the alkyl may be methyl, ethyl, propyl, or a combination thereof. If a substitution is present, the substitution may include a hydroxy or a sulfo substitution. In addition, in one embodiment, the cellulose ether may be soluble in water at ambient temperature. In one embodiment, the cellulose ether may be nonionic. The cellulose ether may be an alkyl cellulose, a hydroxyalkyl cellulose, or a mixture thereof. The cellulose ether may include, but is not limited to methylcellulose, ethyl cellulose, propyl cellulose, butyl cellulose, hydroxyethyl methylcellulose, hydroxypropyl methylcellulose, hydroxypropylhydroxyethylcellulose, hydroxyethyl cellulose, ethylhydroxyethylcellulose, methylethylhydroxyethylcellulose, methylhydroxyethylcellulose, ethylmethylhydroxypropylcellulose, ethylhydroxyethylcellulose, a carboxyalkylcellulose (e.g., carboxymethylcellulose) etc., and mixtures thereof. The cellulose ether may have a particular degree of substitution (i.e., the average number of substituted hydroxyl groups per glucose united). The degree of substitution may be 0.1 or more, such as 0.2 or more, such as 0.3 or more, such as 0.5 or more, such as 1 or more, such as 1.3 or more, such as 1.5 or more, such as 2 or more. The degree of substitution may be 3 or less, such as 2.8 or less, such as 2.5 or less, such as 2.3 or less, such as 2 or less.

The binder may have a selectively chosen particle size distribution. The particle size distribution of the binder may be monomodal, bi-modal, or multi-modal. In some aspects, a US standard mesh size of 40 may retain from about 0 wt. % to about 30 wt. % of the binder, including all increments of 0.01 wt. % therebetween. For instance, a US standard mesh size of 40 may retain about 0 wt. % of the binder (e.g., hydroxyethyl cellulose) or more, such as about 5 wt. % or more, such as about 10 wt. % or more, such as about 15 wt. % or more, such as about 20 wt. % or more, such as about 30 wt. % or less, such as about 20 wt. % or less, such as about 15 wt. % or less, such as about 10 wt. % or less, such as about 5 wt. % or less.

In general, a binder may be present in the plaster composition in an amount from about 0.001 wt. % to about 5 wt. %, including all increments of 0.001 wt. % therebetween. For instance, a binder may be present in the plaster composition in an amount of about 0.001 wt. % or more, such as about 0.005 wt. % or more, such as about 0.01 wt. % or more, such as about 0.02 wt. % or more, such as about 0.03 wt. % or more, such as about 0.04 wt. % or more, such as about 0.05 wt. % or more, such as about 0.06 wt. % or more, such as about 0.07 wt. % or more, such as about 0.08 wt. % or more, such as about 0.09 wt. % or more, such as about 0.1 wt. % or more, such as about 0.15 wt. % or more, such as about 0.2 wt. % or more, such as about 0.3 wt. % or more, such as about 0.4 wt. % or more, such as about 0.5 wt. % or more, such as about 1 wt. % or more, such as about 2 wt. % or more, such as about 3 wt. % or more, such as about 4 wt. % or more. In general, a binder may be present in the plaster composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.4 wt. % or less, such as about 0.3 wt. % or less, such as about 0.2 wt. % or less, such as about 0.15 wt. % or less, such as about 0.1 wt. % or less, such as about 0.09 wt. % or less, such as about 0.08 wt. % or less, such as about 0.07 wt. % or less, such as about 0.06 wt. % or less, such as about 0.05 wt. % or less, such as about 0.04 wt. % or less, such as about 0.03 wt. % or less, such as about 0.02 wt. % or less, such as about 0.01 wt. % or less.

Generally, the plaster composition may comprise one or more thickeners. The one or more thickeners may comprise one or more starch ethers. In some aspects, a thickener may have a bulk density from about 300 kg/m³ to about 900 kg/m³, including all increments of 1 kg/m³ therebetween. For instance, a thickener of a plaster composition may have a bulk density of 300 kg/m³ or more, such as about 350 kg/m³ or more, such as about 400 kg/m³ or more, such as about 450 kg/m³ or more, such as about 500 kg/m³ or more, such as about 550 kg/m³ or more, such as about 600 kg/m³ or more, such as about 650 kg/m³ or more, such as about 700 kg/m³ or more, such as about 750 kg/m³ or more, such as about 800 kg/m³ or more, such as about 850 kg/m³ or more, such as about 900 kg/m³ or less, such as about 850 kg/m³ or less, such as about 800 kg/m³ or less, such as about 750 kg/m³ or less, such as about 700 kg/m³ or less, such as about 650 kg/m³ or less, such as about 600 kg/m³ or less, such as about 550 kg/m³ or less, such as about 500 kg/m³ or less, such as about 450 kg/m³ or less, such as about 400 kg/m³ or less, such as about 350 kg/m³ or less.

In some aspects, a thickener may have a viscosity from about 1 mPa·s to about 100 mPa·s, including all increments of 1 mPa·s therebetween. For instance, a thickener may have a viscosity of about 1 mPa·s or more, such as about 10 mPa·s or more, such as about 20 mPa·s or more, such as about 30 mPa·s or more, such as about 40 mPa·s or more, such as about 50 mPa·s or more, such as about 60 mPa·s or more, such as about 70 mPa·s or more, such as about 80 mPa·s or more, such as about 90 mPa·s or more. A thickener may have a viscosity of about 100 mPa·s or less, such as about 90 mPa·s or less, such as about 80 mPa·s or less, such as about 70 mPa·s or less, such as about 60 mPa·s or less, such as about 50 mPa·s or less, such as about 40 mPa·s or less, such as about 30 mPa·s or less, such as about 20 mPa·s or less, such as about 10 mPa·s or less. The viscosity of the thickener may be determined by a falling ball viscometer, such as a Höeppler falling ball viscometer.

In some aspects, a thickener may be present in the plaster composition in an amount from about 0.001 wt. % to about 5 wt. %, including all increments of 0.001 wt. % therebetween. For instance, a thickener may be present in the plaster composition in an amount of about 0.001 wt. % or more, such as about 0.005 wt. % or more, such as about 0.01 wt. % or more, such as about 0.02 wt. % or more, such as about 0.03 wt. % or more, such as about 0.04 wt. % or more, such as about 0.05 wt. % or more, such as about 0.06 wt. % or more, such as about 0.07 wt. % or more, such as about 0.08 wt. % or more, such as about 0.09 wt. % or more, such as about 0.1 wt. % or more, such as about 0.15 wt. % or more, such as about 0.2 wt. % or more, such as about 0.3 wt. % or more, such as about 0.4 wt. % or more, such as about 0.5 wt. % or more, such as about 1 wt. % or more, such as about 2 wt. % or more, such as about 3 wt. % or more, such as about 4 wt. % or more. A thickener may be present in the plaster composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.4 wt. % or less, such as about 0.3 wt. % or less, such as about 0.2 wt. % or less, such as about 0.15 wt. % or less, such as about 0.1 wt. % or less, such as about 0.09 wt. % or less, such as about 0.08 wt. % or less, such as about 0.07 wt. % or less, such as about 0.06 wt. % or less, such as about 0.05 wt. % or less, such as about 0.04 wt. % or less, such as about 0.03 wt. % or less, such as about 0.02 wt. % or less, such as about 0.01 wt. % or less.

In some aspects, the plaster composition of the present disclosure may include one or more air entraining agents. The one or more air entraining agents may produce air bubbles, such as micro air bubbles, in the plaster composition that may enhance the workability of the plaster composition. In some aspects, the one or more air entraining agents may be soluble in water. In some aspects, the one or more air entraining agents may include a sulfate (e.g., alkyl ether sulfates), a sulfonate, a fatty acid (e.g., oleic acid, stearic acid), or a combination thereof.

In some aspects, an air entraining agent may be a sulfonate. In this respect, the one or more air entraining agents may include an alkane sulfonate, an alkene (e.g., an α-olefin) sulfonate, and/or an alkyl sulfonate. Notably, the one or more air entraining agents may include a counterion. For instance, the one or more air entraining agents may include sodium and/or potassium. In this respect, in some aspects, the one or more air entraining agents may include a sodium alkane sulfonate, a sodium alkene sulfonate (e.g., a sodium olefin sulfonate), an alpha olefin sulfonate, and/or a sodium alkyl sulfonate.

An air entraining agent and/or any components thereof (e.g., a sulfonate) may have a carbon chain length from 8 carbons to 24 carbons, including all increments of 1 carbon therebetween. For instance, an air entraining agent and/or any components thereof (e.g., an olefin sulfonate) may have a carbon chain length of 8 carbons or more, such as 10 carbons or more, such as 12 carbons or more, such as 14 carbons or more, such as 16 carbons or more, such as 18 carbons or more, such as 20 carbons or more, such as 22 carbons or more. An air entraining agent and/or any components thereof (e.g., an olefin sulfonate) may have a carbon chain length of 24 carbons or less, such as 22 carbons or less, such as 20 carbons or less, such as 18 carbons or less, such as 16 carbons or less, such as 14 carbons or less, such as 12 carbons or less, such as 10 carbons or less. The one or more air entraining agents and/or any components thereof may have a carbon chain length ranging from any of the values previously disclosed. For instance, an air entraining agent and/or any components thereof may have a carbon chain length of C₁₄₋₁₆, C₁₆₋₁₈, and/or C₁₄₋₁₈. Notably, one or more air entraining agents may include a sodium C₁₄₋₁₆ Olefin sulfonate, a sodium C₁₄₋₁₈ Olefin sulfonate, a sodium C₁₆₋₁₈ olefin sulfonate, or a combination thereof.

An air entraining agent may be present in the plaster composition in an amount from about 0.001 wt. % to about 5 wt. %, including all increments of 0.001 wt. % therebetween. For instance, an air entraining agent may be present in the plaster composition in an amount of about 0.001 wt. % or more, such as about 0.005 wt. % or more, such as about 0.01 wt. % or more, such as about 0.02 wt. % or more, such as about 0.03 wt. % or more, such as about 0.04 wt. % or more, such as about 0.05 wt. % or more, such as about 0.06 wt. % or more, such as about 0.07 wt. % or more, such as about 0.08 wt. % or more, such as about 0.09 wt. % or more, such as about 0.1 wt. % or more, such as about 0.15 wt. % or more, such as about 0.2 wt. % or more, such as about 0.3 wt. % or more, such as about 0.4 wt. % or more, such as about 0.5 wt. % or more, such as about 1 wt. % or more, such as about 2 wt. % or more, such as about 3 wt. % or more, such as about 4 wt. % or more. An air entraining agent may be present in the plaster composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.4 wt. % or less, such as about 0.3 wt. % or less, such as about 0.2 wt. % or less, such as about 0.15 wt. % or less, such as about 0.1 wt. % or less, such as about 0.09 wt. % or less, such as about 0.08 wt. % or less, such as about 0.07 wt. % or less, such as about 0.06 wt. % or less, such as about 0.05 wt. % or less, such as about 0.04 wt. % or less, such as about 0.03 wt. % or less, such as about 0.02 wt. % or less, such as about 0.01 wt. % or less.

Generally, the plaster composition may also include one or more retarders. In some aspects, the one or more retarders may include one or more organic retarders, one or more inorganic retarders, or a combination thereof. Notably, in some aspects, the one or more retarders may comprise organic retarders such as a proteinaceous retarder (e.g., SUMA retarder), a degraded mixture of polyamides, or a combination thereof. The one or more retarders may comprise one or more retarders that are salified. In this respect, in some aspects, the one or more retarders may comprise a degraded mixture of polyamides, salified with calcium. In some aspects, the one or more retarders may comprise tartaric acid.

In some aspects, one or more retarders may be present in the plaster composition in an amount from about 0.001 wt. % to about 5 wt. %, including all increments of 0.001 wt. % therebetween. For instance, a retarder may be present in the plaster composition in an amount of about 0.001 wt. % or more, such as about 0.005 wt. % or more, such as about 0.01 wt. % or more, such as about 0.02 wt. % or more, such as about 0.03 wt. % or more, such as about 0.04 wt. % or more, such as about 0.05 wt. % or more, such as about 0.06 wt. % or more, such as about 0.07 wt. % or more, such as about 0.08 wt. % or more, such as about 0.09 wt. % or more, such as about 0.1 wt. % or more, such as about 0.15 wt. % or more, such as about 0.2 wt. % or more, such as about 0.3 wt. % or more, such as about 0.4 wt. % or more, such as about 0.5 wt. % or more, such as about 1 wt. % or more, such as about 2 wt. % or more, such as about 3 wt. % or more, such as about 4 wt. % or more. A retarder may be present in the plaster composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.4 wt. % or less, such as about 0.3 wt. % or less, such as about 0.2 wt. % or less, such as about 0.15 wt. % or less, such as about 0.1 wt. % or less, such as about 0.09 wt. % or less, such as about 0.08 wt. % or less, such as about 0.07 wt. % or less, such as about 0.06 wt. % or less, such as about 0.05 wt. % or less, such as about 0.04 wt. % or less, such as about 0.03 wt. % or less, such as about 0.02 wt. % or less.

In some aspects, the plaster composition may include hydrated lime in an amount of about 0.01 wt. % or more, such as about 1 wt. % or more, such as about 5 wt. % or more, such as about 10 wt. % or more, such as about 15 wt. % or more, such as about 25 wt. % or more, such as about 30 wt. % or more, such as about 40 wt. % or more, such as about 50 wt. % or more, such as about 60 wt. % or more. The plaster composition may include hydrated lime in an amount of about 70 wt. % or less, such as about 60 wt. % or less, such as about 50 wt. % or less, such as about 40 wt. % or less, such as about 30 wt. % or less, such as about 25 wt. % or less, such as about 15 wt. % or less, such as about 10 wt. % or less, such as about 5 wt. % or less, such as about 1 wt. % or less.

### Joint Compound Composition

Notably, the second stucco composition may be incorporated into a joint compound composition (e.g., a setting-type joint compound composition). In some aspects, a joint compound composition may include the first stucco composition and the second stucco composition.

In some aspects, a joint compound composition may comprise a stucco composition (e.g., a first stucco composition, a second stucco composition) in an amount of about 0.1 wt. % or more, such as about 1 wt. % or more, such as about 5 wt. % or more, such as about 10 wt. % or more, such as about 15 wt. % or more, such as about 25 wt. % or more, such as about 50 wt. % or more. A stucco composition may be present in the joint compound composition in an amount of about 100 wt. % or less, such as about 50 wt. % or less, such as about 40 wt. % or less, such as about 30 wt. % or less, such as about 25 wt. % or less, such as about 20 wt. % or less, such as about 15 wt. % or less, such as about 10 wt. % or less, such as about 5 wt. % or less.

The joint compound composition may include a filler. The filler may include limestone, calcium carbonate, calcium magnesium carbonate, calcium sulfate dihydrate, or a mixture thereof. In one embodiment, the filler may include calcium carbonate. In another embodiment, the filler may include calcium magnesium carbonate. In a further embodiment, the filler may include calcium sulfate dihydrate. In another further embodiment, the filler may include a mixture of at least two of calcium carbonate, calcium magnesium carbonate, and calcium sulfate dihydrate, such as a mixture of calcium carbonate and calcium magnesium carbonate, a mixture of calcium carbonate and calcium sulfate dihydrate, or a mixture of calcium magnesium carbonate and calcium sulfate dihydrate. In a further embodiment, the filler may include a mixture of calcium carbonate, calcium magnesium carbonate, and calcium sulfate dihydrate.

Regardless, the filler may be present in an amount of at least 5 wt. %, such as at least 10 wt. %, such as at least 20 wt. %, such as at least 30 wt. %, such as at least 35 wt. %, such as at least 40 wt. %, such as at least 45 wt. %, such as at least 50 wt. % based on the weight of the joint compound composition. The filler may be present in an amount of 70 wt. % or less, such as 60 wt. % or less, such as 55 wt. % or less, such as 50 wt. % or less, such as 45 wt. % or less, such as 40 wt. % or less based on the weight of the joint compound composition. In addition, it should be understood that the aforementioned weight percentages may apply to a single filler used alone as well as a mixture of fillers.

In addition, the joint compound composition may include a mineral filler. The mineral filler may include a silicate. The silicate may be a nesosilicate, a sorosilicate, a cyclosilicate, an inosilicate, a phyllosilicate, a tectosilicate, or a mixture thereof. In one particular embodiment, the silicate may be a phyllosilicate. For instance, the mineral filler may include kaolin, montmorillonite, vermiculite, perlite, illite, halloysite, talc, pyrophyllite, palygorskite, attapulgite clay, sepiolite, mica, or a mixture thereof. In particular, the mineral filler may comprise mica, talc, pyrophyllite, or a mixture thereof. In one embodiment, the mineral filler may include mica. In another embodiment, the mineral filler may include talc. In another embodiment, the mineral filler may include pyrophyllite. In a further embodiment, the mineral filler may include a mixture of at least two of mica, talc, and pyrophyllite. For instance, the mineral filler may include a mixture of mica and talc. Alternatively, the mineral filler may include a mixture of talc and pyrophyllite. In another embodiment, the mineral filler may include a mixture of mica and pyrophyllite. In another further embodiment, the mineral filler may include a mixture of mica, talc, and pyrophyllite.

In some aspects, the joint compound composition may include one or more polymers, such as a polyvinyl acetate copolymer, an acrylic polymer, or a styrene-butadiene polymer.

Generally, the joint compound composition may include a siloxane polymer. For instance, the siloxane polymer may be a dialkylsiloxane polymer. In this regard, the alkyl may be a C₁-C₄ alkyl, such as a C₁-C₂ alkyl, such as a C₁ alkyl (i.e., methyl). Accordingly, the siloxane polymer may be a dimethylsiloxane polymer (polydimethylsiloxane). Furthermore, the siloxane polymer may be modified. The modification may be a terminal modification or a side chain modification (e.g., to the alkyl, such as the methyl). In one embodiment, the modification is a terminal modification. In another embodiment, the modification is a side chain modification. Regardless, the modification may be by using a polyether to provide a polyether siloxane polymer (in other words a dimethicone copolyol). The polyether may be formed from polyethylene glycol, polypropylene glycol, or a mixture thereof. Such polyether may have 2 or more, such as 3 or more, such as 4 or more, such as 5 or more, such as 8 or more, such as 10 or more moles or repeat units. Such polyether may have 30 or less, such as 25 or less, such as 20 or less, such as 18 or less, such as 16 or less, such as 12 or less, such as 10 or less, such as 8 or less moles or repeat units. In one particular embodiment, the modification is a polyethylene glycol to provide a polyoxyethylene modified siloxane polymer, in particular a polyoxyethylene modified polydimethylsiloxane.

Regardless, the siloxane polymer may be present in an amount of 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.75 wt. % or more, such as 1 wt. % or more based on the weight of the joint compound composition. The siloxane polymer may be present in an amount of 5 wt. % or less, such as 4 wt. % or less, such as 3 wt. % or less, such as 2 wt. % or less, such as 1.5 wt. % or less, such as 1.25 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less based on the weight of the joint compound composition.

In addition, the joint compound composition may also include a binder. The binder may include an acetate polymer, an acrylic polymer, a polyvinyl alcohol, a cellulose polymer, a starch, etc., or a mixture thereof. In one embodiment, the binder may include at least two of an acetate polymer, an acrylic polymer, a polyvinyl alcohol, a cellulose polymer, or a starch. For instance, in one embodiment, the binder may include at least a mixture of an acetate polymer and a cellulose polymer. In a further embodiment, the binder may include at least an acetate polymer. In another further embodiment, the binder may include at least a cellulose polymer.

The acetate polymer may include a vinyl acetate, such as an ethylene vinyl acetate. For instance, the acetate polymer may be a polyvinyl acetate, a polyethylene vinyl acetate, or a mixture thereof. In one embodiment, the acetate polymer may include polyvinyl acetate. In another embodiment, the acetate polymer may include polyethylene vinyl acetate. In an even further embodiment, the acetate polymer may be a mixture of two acetate polymers, such as any two of the aforementioned.

The acrylic polymer may be any acrylic polymer. For instance, the acrylic polymer may be a polyacrylate. In a further embodiment, the acrylic polymer may be a polyvinyl acrylic polymer. In another further embodiment, the acrylic polymer may be a polyvinyl acetate acrylate. In an even further embodiment, the acrylic polymer may be a mixture of two acrylic polymers, such as any two of the aforementioned.

The cellulose polymer may include a cellulose ether. For instance, the cellulose ether may include one wherein the hydroxyl groups are partially or fully replaced by —OR groups, wherein R is a substituted or substituted alkyl. For instance, the alkyl may be a C₁-C₆ alkyl. In particular, the alkyl may be methyl, ethyl, propyl, or a combination thereof. If a substitution is present, the substitution may include a hydroxy or a sulfo substitution. In addition, in one embodiment, the cellulose ether may be soluble in water at ambient temperature. The cellulose ether may be an alkyl cellulose, a hydroxyalkyl cellulose, or a mixture thereof. The cellulose ether may include, but is not limited to methylcellulose, ethyl cellulose, propyl cellulose, butyl cellulose, hydroxyethyl methylcellulose, hydroxypropyl methylcellulose, hydroxyethyl cellulose, ethylhydroxyethylcellulose, methylethylhydroxyethylcellulose, methylhydroxyethylcellulose, ethylmethylhydroxypropylcellulose, ethylhydroxyethylcellulose, etc., and mixtures thereof. In one particular embodiment, the cellulose ether may be a hydroxypropyl methylcellulose. The cellulose ether may have a particular degree of substitution (i.e., the average number of substituted hydroxyl groups per glucose united). The degree of substitution may be 0.1 or more, such as 0.2 or more, such as 0.3 or more, such as 0.5 or more, such as 1 or more, such as 1.3 or more, such as 1.5 or more, such as 2 or more. The degree of substitution may be 3 or less, such as 2.8 or less, such as 2.5 or less, such as 2.3 or less, such as 2 or less.

Regardless, the binder may be present in an amount of 0.001 wt. % or more, such as 0.01 wt. % or more, such as 0.05 wt. % or more, such as 0.1 wt. % or more, such as 0.2 wt. % or more, such as 0.25 wt. % or more, such as 0.3 wt. % or more, such as 0.4 wt. % or more, such as 0.5 wt. % or more, such as 0.6 wt. % or more, such as 0.7 wt. % or more, such as 0.8 wt. % or more, such as 0.9 wt. % or more, such as 1 wt. % or more based on the weight of the joint compound composition. The binder may be present in an amount of 10 wt. % or less, such as 8 wt. % or less, such as 6 wt. % or less, such as 5 wt. % or less, such as 4 wt. % or less, such as 3 wt. % or less, such as 2 wt. % or less, such as 1.5 wt. % or less, such as 1.4 wt. % or less, such as 1.3 wt. % or less, such as 1.2 wt. % or less, such as 1.1 wt. % or less, such as 1 wt. % or less, such as 0.9 wt. % or less, such as 0.8 wt. % or less, such as 0.7 wt. % or less, such as 0.6 wt. % or less, such as 0.5 wt. % or less, such as 0.4 wt. % or less, such as 0.3 wt. % or less, such as 0.2 wt. % or less, such as 0.1 wt. % or less, such as 0.05 wt. % or less, such as 0.01 wt. % or less based on the weight of the joint compound composition. In addition, it should be understood that the aforementioned weight percentages may apply to a single binder used alone as well as a mixture of binders.

In addition, in one embodiment, the joint compound composition may also include other additional fillers. For instance, these other additional fillers may include perlite, glass, etc. In one embodiment, the additional filler may include perlite. The perlite may be unexpanded perlite, expanded perlite, or a mixture thereof. In one embodiment, the perlite may include expanded perlite. In another embodiment, the additional filler may include a glass.

The additional filler, such as the perlite, may be treated. In one embodiment, it may remain untreated. In another embodiment, it may be treated such as to providing a coating. For instance, the treatment may be a hydrophobic treatment to provide a hydrophobic filler, such as a hydrophobic perlite. Such hydrophobicity may be obtained by treated the perlite with a surface-active agent. In this regard, the treatment and coating may be with one or more silanes, siloxanes, silicone coatings, or a mixture thereof. These may include in particular, but are not limited to, dimethyl silicone, dimethyldichlorosilane or polydimethylsiloxane. In addition or alternatively, coatings may also include titanates or zirconates. The coating may be provided in an amount of 0.01 wt. % or more, such as 0.02 wt. % or more, such as 0.05 wt. % or more, such as 0.1 wt. % or more, such as 0.2 wt. % or more, such as 0.5 wt. % or more to 5 wt. % or less, such as 4 wt. % or less, such as 3 wt. % or less, such as 2.5 wt. % or less, such as 2 wt. % or less, such as 1.5 wt. % or less, such as 1 wt. % or less based on the uncoated weight of the filler, such as the perlite.

Regardless, the additional filler may be present in an amount of at least 0.01 wt. %, such as at least 0.05 wt. %, such as at least 0.1 wt. %, such as at least 0.5 wt. %, such as at least 1 wt. %, such as at least 2 wt. %, such as at least 5 wt. %, such as at least 6 wt. %, such as at least 8 wt. %, such as at least 10 wt. % based on the weight of the joint compound composition. The additional filler may be present in an amount of 30 wt. % or less, such as 25 wt. % or less, such as 20 wt. % or less, such as 15 wt. % or less, such as 13 wt. % or less, such as 11 wt. % or less, such as 10 wt. % or less, such as 8 wt. % or less, such as 6 wt. % or less, such as 5 wt. % or less, such as 2 wt. % or less, such as 1 wt. % or less, such as 0.5 wt. % or less, such as 0.1 wt. % or less based on the weight of the joint compound composition. In addition, it should be understood that the aforementioned weight percentages may apply to a single additional filler used alone as well as a mixture of additional fillers.

### EXAMPLES

It should be understood that for all Samples in which the stucco was conditioned and had water or a coating composition applied thereon, the stucco was conditioned after having the water or the coating composition applied thereon.

### Test Methods

Slump Test: The test is conducted after wiping a brass cylinder having a wall thickness of about 0.07 inches, a height of about 4 inches, and an inner diameter of about 2 inches with a low-viscosity lubricating oil. The brass cylinder has a volume of 76 cc. Excess oil was drained off the surfaces of the cylinder. The cylinder then was placed upright onto a center portion of a clean (i.e., no scratches), dry glass plate having the following dimensions: about 10 inches in length, about 10 inches in width, and about 0.1875 inch thick. A gypsum patty was poured into the cylinder such that the cylinder was completely filled with a slight excess. The scoop can be a clean metal or plastic scoop of convenient size or can be formed from disposable gypsum board paper. The excess was screed off to a level with the top of the cylinder without dropping any of the gypsum patty onto the surface of the glass plate. Immediately, and at least within about 10 seconds of removing excess gypsum patty, the cylinder was raised vertically with a smooth and uniform motion at a moderate (not rapid) speed, and the gypsum patty contained within the cylinder was allowed to slump to a circular patty onto the surface of the glass plate. After the gypsum patty had solidified, the glass plate was turned over and the diameter of the slump in contact with the glass plate was measured to the nearest millimeter. In particular, the average of two measurements was reported wherein the measurements are taken at right angles to each other.

Consistency: The consistency is the volume of water required per gram of stucco to obtain a slump of 3 inches (76.2 mm) using the Slump Test.

Hot Consistency: The hot consistency is the volume of water required per gram of stucco to obtain a slump of 3 inches (76.2 mm) using the Slump Test. The stucco has a temperature of about 170° F. when combined with the water.

Conditioned Consistency: The conditioned consistency is the volume of water required per gram of stucco to obtain a slump of 3 inches (76.2 mm) using the Slump Test. The stucco was conditioned at a temperature of 70° F. and 50% RH for 12 hours and had a temperature of 70° F. when combined with the water.

Nail Pull: The nail pull is determined in accordance with ASTM C1396-17 and ASTM C473-19. For this test, the specimens are conditioned from 70° F. to 100° F., in particular 70° F., and 50%+/−2% relative humidity for at least 24 hours, positioned so they do not warp. The moisture meter reading should be between 10-20 at the time of testing. The nail pull resistance average is the average of five specimens and the nail pull resistance standard deviation is the standard deviation of the five specimens.

Humidified Bond: A humidified bond analysis is performed utilizing 12″ by 12″ specimens of the gypsum panel. The specimens are placed on edge in a humidity chamber at 90° F. and 90% humidity with faces 2+/−¼ inches apart. As reported below, the exposure was for 2 hours. The specimens should have a moisture meter reading of 50+ upon completion of the humidification. Immediately, the specimens were analyzed to determine the bond. First, score lines should be scribed across the full width of the sample at 4″ from one edge on the face and 4″ in from the opposite edge on the back wherein the score lines are parallel to one another and perpendicular to the direction of machine travel. Next, firmly hold the specimen on a bench top and while face up, break the core along a score line and leave the paper intact on the side to be evaluated. Holding each portion of the specimen in separate hands and having the exposed broken core in a line of vision, exert a pulling force on one half of the specimen while holding the other half in a steady position in order to peel or tear the paper away from the core. Continue the pulling force until the paper peels away from the core to the maximum extent possible. Repeat this pulling action for the companion portion of the specimen. Then, repeat both steps for the back of the specimen. Next, determine the bond failure area where the facing material is removed from the gypsum core, with 100% indicative of no paper to gypsum core bond and 0% indicative of no paper to core failure (i.e., full paper bond to the core).

Stiffening Time: The stiffening time is the amount of time for a line drawn through the gypsum patty to remain visible (e.g., unhealed). In particular, a paper clip tip or metal spatula having a 1 mm thickness is used to draw a line through the gypsum patty. The stiffening time was determined as the time at which the line remained visible, or it no longer healed.

Set Time: The initial or ¼ lb set time is the time until set as determined according to ASTM C266 using a ¼ lb Gilmore needle.

### Example 1

To perform the Slump Test, gypsum patties were made which included 50 grams of stucco and 38 grams of water. The weight ratio of water to stucco in the gypsum patties was 0.76. Notably, for Samples 1-4, the stucco used to form the gypsum patties had a coating composition applied thereon. The respective coating compositions were applied in various weight percentages based on the weight of the stucco. The coating compositions were applied to the stucco when the stucco had a temperature of 250° F. The coating compositions had a temperature from about 60° F. to about 70° F. The temperature of the stucco was determined by an infrared thermometer.

For Samples 2-4, a 20% solution of dextrose and/or a 20% solution of naphthalene sulfonate was applied to the stucco until the respective wt. % based on the weight of the stucco of the dextrose and/or the naphthalene sulfonate stated in Table 1 was achieved. In this respect, the coating compositions were a 20% solution of dextrose and/or a 20% solution of naphthalene sulfonate.

For Sample 1, a coating composition comprising only water was applied to the stucco in an amount of 1.5 wt. % based on the weight of the stucco.

For Sample 2, the coating composition comprising the solution of water and naphthalene sulfonate was applied to the stucco. The water was applied in an amount of 1.2 wt. % based on the weight of stucco and the naphthalene sulfonate was applied in an amount of 0.3 wt. % based on the weight of stucco.

For Sample 3, the coating composition comprising the solution of water and dextrose was applied to the stucco. The water was applied in an amount of 1.2 wt. % based on the weight of stucco and the dextrose was applied in an amount of 0.3 wt. % based on the weight of stucco.

For Sample 4, the coating composition comprising the solution of water and dextrose was applied to the stucco. Then, the coating composition comprising the solution of water and the naphthalene sulfonate was applied to the stucco. The water was applied in an amount of 2.4 wt. % based on the weight of stucco, the dextrose was applied in an amount of 0.3 wt. % based on the weight of stucco, and the naphthalene sulfonate was applied in an amount of 0.3 wt. % based on the weight of stucco.

Samples 1-4 were all tested in accordance with the above Slump Test.

Additionally, 50 grams of stucco was coated with the coating compositions of Samples 1~4 as previously disclosed herein and as illustrated in Table 1. In this respect, 50 grams of stucco had a coating composition applied thereon. The coating compositions were applied to the stucco when the stucco had a temperature of 250° F. The coating compositions had a temperature from about 60° F. to about 70° F. A 20% solution of dextrose and/or a 20% solution of naphthalene sulfonate was applied to the stucco until the respective wt. % based on the weight of the stucco of the dextrose and/or the naphthalene sulfonate stated in Table 1 was achieved. The coated stucco compositions were not conditioned. Then, the coated stucco compositions were each tested in accordance with the above Hot Consistency test.

Further, 50 grams of stucco was coated with coating compositions of Samples 2-4 previously disclosed herein and as illustrated in Table 1. In this respect, 50 grams of stucco had a coating composition applied thereon. The coating compositions were applied to the stucco when the stucco had a temperature of 250° F. The coating compositions had a temperature from about 60° F. to about 70° F. A 20% solution of dextrose and/or a 20% solution of naphthalene sulfonate was applied to the stucco until the respective wt. % based on the weight of the stucco of the dextrose and/or the naphthalene sulfonate stated in Table 1 was achieved. The coated stucco compositions were conditioned and tested in accordance with the above Conditioned Consistency test.

Additionally, for Control 1, 50 grams of stucco were conditioned and tested in accordance with the above Conditioned Consistency test. The stucco of Control 1 did not have a coating composition applied thereon.

It should be understood that the Slump Test, the Hot Consistency test, and the Conditioned Consistency test were tested separately. Table 1 illustrates the slump, hot consistency, and conditioned consistency of Control 1 and Samples 1-4. Notably, a “-” means that the respective test was not performed for the respective Control or Sample.

TABLE 1

| | | | Naphthalene | | Hot | Conditioned |
|---|---|---|---|---|---|---|
| | Water | Dextrose | Sulfonate | Slump | Consistency | Consistency |
| Sample | [wt. %] | [wt. %] | [wt. %] | [mm] | [cc/g] | [cc/g] |
| Control 1 | 0.0 | 0.0 | 0.0 | — | — | 0.75 |
| 1 | 1.5 | 0.0 | 0.0 | 91 | 0.72 | — |
| 2 | 1.2 | 0.0 | 0.3 | 119 | 0.67 | 0.60 |
| 3 | 1.2 | 0.3 | 0.0 | 112 | 0.66 | 0.62 |
| 4 | 2.4 | 0.3 | 0.3 | 126 | 0.65 | 0.57 |

### Example 2

Gypsum patties were made which included 50 grams of stucco and 30 grams of water. The weight ratio of water to stucco in the gypsum patties was 0.6. Notably, the stucco used to form the gypsum patties was conditioned at a temperature of 70° F. and 50% RH for 12 hours. For Samples 5-12, the stucco used to form the gypsum patties had a coating composition applied thereon. The respective coating compositions were applied in various weight percentages based on the weight of the stucco. The coating compositions were applied to the stucco when the stucco had a temperature of 250° F. The coating compositions had a temperature from about 60° F. to about 70° F. The temperature of the stucco was determined by an infrared thermometer.

For Control 2, water was applied to the stucco.

For Samples 5-12, a 20% solution of dextrose or a 20% solution of lignosulfonate was applied to the stucco until the respective wt. % based on the weight of the stucco of the dextrose and/or the lignosulfonate stated in Table 2 was achieved. In this respect, the coating compositions were a 20% solution of dextrose or a 20% solution of lignosulfonate. For instance, for Sample 8, a 20% solution of a lignosulfonate was applied to the stucco until the amount of lignosulfonate applied was 0.58 wt. % based on the weight of the stucco.

For Sample 5, the solution of water and a lignosulfonate was applied to the stucco such that the lignosulfonate was applied in an amount of 0.188 wt. % based on the weight of the stucco.

For Sample 6, the solution of water and a lignosulfonate was applied to the stucco such that the lignosulfonate was applied in an amount of 0.34 wt. % based on the weight of the stucco.

For Sample 7, the solution of water and a lignosulfonate was applied to the stucco such that the lignosulfonate was applied in an amount of 0.52 wt. % based on the weight of the stucco.

For Sample 8, the solution of water and a lignosulfonate was applied to the stucco such that the lignosulfonate was applied in an amount of 0.58 wt. % based on the weight of the stucco.

For Sample 9, the solution of water and dextrose was applied to the stucco such that the dextrose was applied in an amount of 0.186 wt. % based on the weight of the stucco.

For Sample 10, the solution of water and dextrose was applied to the stucco such that the dextrose was applied in an amount of 0.32 wt. % based on the weight of the stucco.

For Sample 11, the solution of water and dextrose was applied to the stucco such that the dextrose was applied in an amount of 0.36 wt. % based on the weight of the stucco.

For Sample 12, the solution of water and dextrose was applied to the stucco such that the dextrose was applied in an amount of 0.40 wt. % based on the weight of the stucco.

Table 2 illustrates the slump, which is tested in accordance with the above Slump Test.

TABLE 2

| | Dextrose | Lignosulfonate | Slump |
|---|---|---|---|
| Sample | [wt. %] | [wt. %] | [mm] |
| Control 2 | 0.0 | 0.0 | 110 |
| 5 | 0.0 | 0.188 | 150 |
| 6 | 0.0 | 0.34 | 155 |
| 7 | 0.0 | 0.52 | 160 |
| 8 | 0.0 | 0.58 | 150 |
| 9 | 0.186 | 0.0 | 110 |
| 10 | 0.32 | 0.0 | 110 |
| 11 | 0.36 | 0.0 | 125 |
| 12 | 0.40 | 0.0 | 135 |

### Example 3

Gypsum panels having a thickness of ½″ were formed in accordance with the present disclosure. The gypsum panels included a first facing material comprising paper, a second facing material comprising paper, and a gypsum core. The gypsum core of the gypsum panel was formed from a gypsum slurry comprising water and stucco. The water and stucco were present in the gypsum slurry in the weight ratios displayed in Tables 3 and 4. The amount of soap added, the foam volume added to the gypsum slurry via the added soap, and the amount of dispersant added to the gypsum slurry are also displayed in Tables 3 and 4. The amount of soap added is in grams and the amount of dispersant added is based on the weight of stucco used to form the gypsum slurry. It should be understood that Tables 3 and 4 refer to the same samples. Notably, for Samples 13-16, the stucco had a coating composition applied thereon. The coating compositions were applied to the stucco when the stucco had a temperature of 250° F. The temperature of the stucco was determined by an infrared thermometer.

Notably, Control 3 and Control 4 utilized 0.35 grams of soap, which was increased for the remaining samples.

For Samples 13-16, a coating composition comprising water and a lignosulfonate was applied to the stucco of the gypsum slurry. In this respect, for Samples 13-16, a 20% solution of lignosulfonate was applied to the stucco until the respective wt. % of the lignosulfonate based on the weight of the stucco, as stated in Table 3 and Table 4, was achieved. For instance, for Sample 13, a 20% solution of a lignosulfonate was applied to the stucco until the amount of lignosulfonate applied was 0.24 wt. % based on the weight of the stucco used to form the gypsum slurry.

Table 3 illustrates the nail pull resistance average of the respective samples, which is tested in accordance with the above test methods.

Table 4 illustrates the nail pull resistance standard deviation, the humidified bond of the face of the respective samples, and the humidified bond of the back of the respective samples, which are tested in accordance with the above test methods. As used in Table 4, the term “Back” refers to the second facing material, and the term “Face” refers to the first facing material.

TABLE 3

| | Weight | | | | | |
|---|---|---|---|---|---|---|
| | Ratio | | | | | |
| | of | | Foam | | | Nail Pull |
| | Water | Amount | Volume | Amount of | Board | Resistance |
| | to | of Soap | Added | Dispersant | Weight | Average |
| Sample | Stucco | [grams] | [cc] | [wt. %] | [lbs/MSF] | [lbf] |
| Control | 0.84 | 0.35 | 890 | 0.24 | 1646 | 93 |
| 3 | | | | | | |
| Control | 0.84 | 0.35 | 890 | 0.24 | 1723 | 102 |
| 4 | | | | | | |
| 13 | 0.71 | 0.43 | 1082 | 0.24 | 1682 | 87 |
| 14 | 0.67 | 0.50 | 1273 | 0.24 | 1666 | 76 |
| 15 | 0.67 | 0.45 | 1146 | 0.48 | 1749 | 101 |
| 16 | 0.67 | 0.50 | 1274 | 0.48 | 1683 | 90 |

TABLE 4

| | Nail Pull | | |
|---|---|---|---|
| | Resistance | Humidified | Humidified |
| | Standard | Bond | Bond |
| | Deviation | (Face) | (Back) |
| Sample | [lbf] | [%] | [%] |
| Control 3 | 5 | 0 | 0 |
| Control 4 | 10 | 0 | 0 |
| 13 | 6 | 0 | 0 |
| 14 | 9 | 2 | 25 |
| 15 | 12 | 0 | 2 |
| 16 | 5 | 2 | 10 |

### Example 4

Gypsum patties were made which included 50 grams of stucco. Notably, the amount of water added to form the gypsum patties is displayed in Table 5 via the Consistency. For instance, for Sample 17, 60 cc of water were used to form the gypsum patty. Further, for instance, for Sample 20, 67 cc of water were used to form the gypsum patty. Notably, the stucco used to form the gypsum patties, except for the stucco of Control 5, was conditioned at a temperature of 70° F. and 50% RH for 12 hours. For Control 5, a coating composition was not applied or mixed with the stucco of the gypsum patty.

For Control 6, a coating composition was not applied or mixed with the stucco of the gypsum patty. Notably, the stucco of Control 6 is different from the stucco of Control 5 in that the stucco of Control 6 was conditioned as described above.

For Samples 17-19, the stucco used to form the gypsum patties had a coating composition applied thereon. The respective coating compositions were applied in various weight percentages based on the weight of the stucco. The coating compositions were applied to the stucco when the stucco had a temperature of 250° F. The coating compositions had a temperature from about 60° F. to about 70° F. The temperature of the stucco was determined by an infrared thermometer.

For Samples 20-21, the coating composition was not applied to the stucco and was instead mixed in with the stucco and the water in a container.

Notably, for Samples 17-19, a 20% solution of dextrose and/or a 20% solution of a naphthalene sulfonate was applied to the stucco until the respective wt. % based on the weight of the stucco of the respective additive stated in Table 5 was achieved. For instance, for Sample 17, a 20% solution of dextrose was applied to the stucco until the amount of dextrose applied was 0.3 wt. % based on the weight of the stucco in the gypsum patty.

Notably, for Samples 20-21, dextrose or naphthalene sulfonate was mixed with the water and the stucco until the respective wt. % based on the weight of the stucco of the respective additive stated in Table 5 was achieved. For instance, for Sample 20, dextrose was added until the amount of dextrose added to the mixture was 0.3 wt. % based on the weight of the stucco in the mixture that forms the gypsum patty.

Table 5 displays the consistency, the stiffening time, and the set time, which are tested in accordance with the above test methods.

TABLE 5

| | | Naphthalene | | Stiffening | Set |
|---|---|---|---|---|---|
| | Dextrose | Sulfonate | Consistency | Time | Time |
| Sample | [wt. %] | [wt. %] | [cc/g] | [min:sec] | [min:sec] |
| Control | 0.0 | 0.0 | 0.72 | 2:09 | 6:34 |
| 5 | | | | | |
| Control | 0.0 | 0.0 | 0.67 | 2:28 | 7:50 |
| 6 | | | | | |
| 17 | 0.30 | 0.0 | 0.60 | 4:50 | 12:20 |
| 18 | 0.0 | 0.30 | 0.61 | 3:07 | 8:45 |
| 19 | 0.30 | 0.30 | 0.57 | 4:36 | 13:35 |
| 20 | 0.30 | 0.0 | 0.67 | 2:30 | 8:15 |
| 21 | 0.0 | 0.30 | 0.64 | 2:25 | 6:55 |

As observed in Table 5, Sample 17, which involved the application of the coating composition to the stucco, reduced the consistency of the gypsum patty by 10.4% as compared to Control 6. Sample 20, which involved the mixing of the coating composition with the stucco, did not change the consistency. As also observed in Table 5, Sample 18, which involved the application of the coating composition to the stucco, reduced the consistency of the gypsum patty by 9.0% as compared to Control 6. Sample 21, which involved the mixing of the coating composition with the stucco, reduced the consistency of the gypsum patty by 4.5%.

### Example 5

Gypsum patties were made which included 50 grams of stucco and 38 grams of water. The weight ratio of water to stucco in the gypsum patties was 0.76. Notably, the stucco used to form the gypsum patties was conditioned at a temperature of 70° F. and 50% RH for 12 hours.

For Control 7, a coating composition was not applied to or mixed with the stucco of the gypsum patty.

For Control 8, only water was applied to the stucco of the gypsum patty in an amount of 1.2 wt. % based on the weight of the stucco in the gypsum patty.

For Samples 22-24, the stucco used to form the gypsum patties had a coating composition applied thereon. The respective coating compositions were applied in various weight percentages based on the weight of the stucco. The coating compositions were applied to the stucco when the stucco had a temperature of 250° F. The coating compositions had a temperature from about 60° F. to about 70° F. The temperature of the stucco was determined by an infrared thermometer.

Notably, for Samples 22-24, a 20% solution of dextrose or a 20% solution of a naphthalene sulfonate was applied to the stucco until the respective wt. % based on the weight of the stucco of the respective additive stated in Table 6 was achieved. For instance, for Sample 22, a 20% solution of dextrose was applied to the stucco until the amount of dextrose applied was 0.3 wt. % based on the weight of the stucco in the gypsum patty.

Table 6 displays the stiffening time and the set time, which are tested in accordance with the above test methods. Notably, as observed in Control 7 and Control 8, the lack of a coating and the coating of the stucco with only water both have a reduced effect on the Slump of a gypsum patty, as compared to the coating of the stucco with the below coating compositions. For instance, Samples 22, 23, and 24 had an increase in Slump of 12.15%, 21.50%, and 30.8% respectively as compared to Control 8.

TABLE 6

| | Weight | | | | | |
|---|---|---|---|---|---|---|
| | Ratio | | | | | |
| | of | | | | | |
| | Water | | Naphthalene | | Stiffening | |
| | to | Dextrose | Sulfonate | Slump | Time | Set Time |
| Sample | Stucco | [wt. %] | [wt. %] | [mm] | [min:sec] | [min:sec] |
| Control 7 | 0.76 | 0.0 | 0.0 | 109 | 4:19 | 12:39 |
| Control 8 | 0.76 | 0.0 | 0.0 | 107 | 4:32 | 13:50 |
| 22 | 0.76 | 0.30 | 0.0 | 120 | 5:50 | 14:45 |
| 23 | 0.76 | 0.60 | 0.0 | 130 | 6:57 | 16:02 |
| 24 | 0.76 | 0.30 | 0.30 | 140 | 5:59 | 14:06 |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A method for making a stucco composition comprising:
calcining gypsum to form a first stucco composition comprising stucco; and
applying a coating composition to the first stucco composition to form a second stucco composition, the coating composition comprising water and a coating additive, the first stucco composition having a temperature of about 70° C. or more when the coating composition is initially applied to the first stucco composition.

2. The method of claim 1, wherein the coating additive comprises a carbohydrate.

3. The method of claim 1, wherein the coating additive comprises a sugar.

4. The method of claim 1, wherein the coating additive comprises dextrose.

5. The method of claim 1, wherein the coating additive comprises a synthetic polymer.

6. The method of claim 1, wherein the coating additive comprises a dispersant.

7. The method of claim 6, wherein the dispersant comprises a sulfonate.

8. The method of claim 6, wherein the dispersant comprises a carboxylate.

9. The method of claim 1, wherein the coating additive is present on the second stucco composition in an amount of about 0.01 wt. % to about 5 wt. % based on the weight of the stucco of the second stucco composition.

10. The method of claim 1, wherein the first stucco composition has a temperature of about 80° C. or more when the coating composition is initially applied to the first stucco composition.

11. The method of claim 1, wherein the first stucco composition has a temperature of about 100° C. or more when the coating composition is initially applied to the first stucco composition.

12. The method of claim 1, wherein the first stucco composition has a temperature of about 200° C. or less when the coating composition is initially applied to the first stucco composition.

13. The method of claim 1, wherein the first stucco composition has a temperature of about 100° C. to about 200° C. when the coating composition is initially applied to the first stucco composition.

14. The method of claim 1, wherein the coating formed from the coating composition covers about 0.1% or more of the surface area of the stucco of the second stucco composition.

15. The method of claim 1, wherein the method further comprises conditioning the second stucco composition.

16. The method of claim 1, wherein the method further comprises applying a second coating composition to the second stucco composition.

17. The method of claim 1, wherein the method further comprises heating and/or reheating the first stucco composition before the coating composition is applied to the first stucco composition.

18. The method of claim 1, wherein the coating composition is in the form of an emulsion.

19. The method of claim 1, wherein the coating composition is in the form of a dispersion.

20. The method of claim 1, wherein:
the first stucco composition has a temperature of about 100° C. or more when the coating composition is initially applied to the first stucco composition; and
the coating additive comprises a carbohydrate, a dispersant, or a combination thereof.

21. The method of claim 20, wherein at least a portion of the coating composition vaporizes after contacting the first stucco composition.

22. The method of claim 21, wherein 10 wt. % or more of the coating composition vaporizes after contacting the first stucco composition.

23. The method of claim 20, wherein the coating additive is present on the second stucco composition in an amount of about 0.01 wt. % to about 5 wt. % based on the weight of the stucco of the second stucco composition.

24. The method of claim 20, wherein the coating composition is applied to the first stucco composition via spraying.

25. A product comprising the second stucco composition formed by the method of claim 1.

26. A method of making a gypsum comprising:
providing a first facing material;
depositing a gypsum slurry comprising the second stucco composition of claim 1 and water onto the first facing material;
providing a second facing material on the gypsum slurry; and
allowing the stucco to convert to calcium sulfate dihydrate.

27. The method of claim 26, wherein:
the water and stucco of the gypsum slurry have a weight ratio of about 0.80 or less; and
the first stucco composition has a temperature of about 100° C. or more.

28. The method of claim 27, wherein the water and the stucco of the gypsum slurry have a weight ratio of about 0.75 or less.

29. The method of claim 27, wherein the first stucco composition has a temperature of about 200° C. or less when the coating composition is initially applied to the first stucco composition.
